(19) United States
(12) Patent Application Publication
(10) Pub. No.: US 2026/0032762 A1
(43) Pub. Date: Jan. 29, 2026

(54) COMMUNICATION METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/349,610

(22) Filed: Oct. 3, 2025

Related U.S. Application Data
(63) Continuation of application No. PCT/JP2024/013917, filed on Apr. 4, 2024.
(60) Provisional application No. 63/494,332, filed on Apr. 5, 2023.

(51) Int. Cl. H04W 76/27

(52) U.S. Cl. CPC H04W 76/27

(57) ABSTRACT

A communication method using a relay apparatus including a relay device configured to perform a relay operation of relaying a radio signal transmitted between a network and a user equipment, and a control terminal configured to receive a control signal used for control of the relay device from the network includes: camping, by the control terminal in an radio resource control (RRC) idle mode, on a suitable cell in which a normal service is provided; and initiating an RRC connection establishment procedure of transitioning to an RRC connected mode based on the control terminal in the RRC idle mode having camped on the suitable cell.

### RELATED APPLICATIONS

The present application is a continuation based on PCT Application No. PCT/JP2024/013917, filed on Apr. 4, 2024, which claims the benefit of U.S. Provisional Patent Application No. 63/494,332 filed on Apr. 5, 2023. The content of which is incorporated by reference herein in their entirety.

### TECHNICAL FIELD

The present disclosure relates to a communication method to be used in a mobile communication system.

### BACKGROUND

In recent years, a mobile communication system of the fifth generation (5G) has been attracting attention. New Radio (NR), which is a radio access technology of the 5G system, is capable of wide-band transmission via a high frequency band compared to Long Term Evolution (LTE), which is a fourth-generation radio access technology.

Since radio signals (radio waves) in the high frequency band such as a millimeter wave band or a terahertz wave band have high rectilinearity, reduction of coverage of a base station is a problem. In order to solve such a problem, a repeater apparatus that is a type of relay apparatus relaying radio signals between the network and a user equipment and can be controlled from a network is attracting attention (see, for example, Non-Patent Document 1).

Such a repeater apparatus can extend the coverage of the base station while suppressing occurrence of interference by, for example, amplifying a radio signal received from the base station and transmitting the radio signal through directional transmission. Such a repeater apparatus is referred to as a Network-controlled Repeater (NCR).

### CITATION LIST

### Non-Patent Literature

Non-Patent Document 1: 3GPP Contribution: RP-213700, “New SI: Study on NR Network-controlled Repeaters”

### SUMMARY

A communication method according to a first aspect is a method using a relay apparatus including a relay device configured to perform a relay operation of relaying a radio signal transmitted between a network and a user equipment, and a control terminal configured to receive a control signal used for control of the relay device from the network. The communication method includes: camping, by the control terminal in a radio resource control (RRC) idle mode, on a suitable cell in which a normal service is provided; and initiating, by the control terminal in the RRC idle mode, an RRC connection establishment procedure of transitioning to an RRC connected mode based on having camped on the suitable cell.

A communication method according to a second aspect is a method using a relay apparatus including a relay device configured to perform a relay operation of relaying a radio signal transmitted between a network and a user equipment, and a control terminal configured to receive a control signal used for control of the relay device from the network. The communication method includes: camping, by the control terminal in a radio resource control (RRC) idle mode, on an acceptable cell in which a limited service is provided; generating, by the control terminal in the RRC idle mode, uplink data in the acceptable cell; and initiating, by the control terminal in the RRC idle mode, an RRC connection establishment procedure of transitioning to an RRC connected mode in response to generating the uplink data.

### BRIEF DESCRIPTION OF THE DRAWINGS

FIG. 1 is a diagram illustrating a configuration of a mobile communication system according to an embodiment.

FIG. 2 is a diagram illustrating a configuration of a protocol stack of a wireless interface of a user plane handling data.

FIG. 3 is a diagram illustrating a configuration of a protocol stack of a wireless interface of a control plane handling signaling (control signal).

FIG. 4 is a diagram illustrating an example of an application scenario of the NCR apparatus (relay apparatus) according to a first embodiment.

FIG. 5 is a diagram illustrating an example of an application scenario of the NCR apparatus according to the first embodiment.

FIG. 6 is a diagram illustrating an example of a control method for the NCR apparatus according to the first embodiment.

FIG. 7 is a diagram for describing a configuration example of a protocol stack in the NCR apparatus according to the first embodiment.

FIG. 8 is a diagram illustrating a configuration example of the NCR apparatus according to the first embodiment.

FIG. 9 is a diagram illustrating a configuration of a user equipment (UE) according to the embodiment.

FIG. 10 is a diagram illustrating a configuration example of a gNB (base station) according to the embodiment.

FIG. 11 is a diagram for describing a typical cell reselection procedure.

FIG. 12 is a diagram illustrating an example of an operation of an NCR-MT (control terminal) according to a first operation pattern of the first embodiment.

FIG. 13 is a diagram illustrating an example of an operation of the NCR-MT according to a second operation pattern of the first embodiment.

FIG. 14 is a diagram illustrating an example of an operation of a mobile communication system according to the second operation pattern of the first embodiment.

FIG. 15 is a diagram for describing the RIS apparatus (relay apparatus) according to the second embodiment.

FIG. 16 is a diagram for describing the RIS apparatus according to the second embodiment.

FIG. 17 is a diagram illustrating an IE for providing a specific PRACH scene (RO) to avoid a possibility of collision.

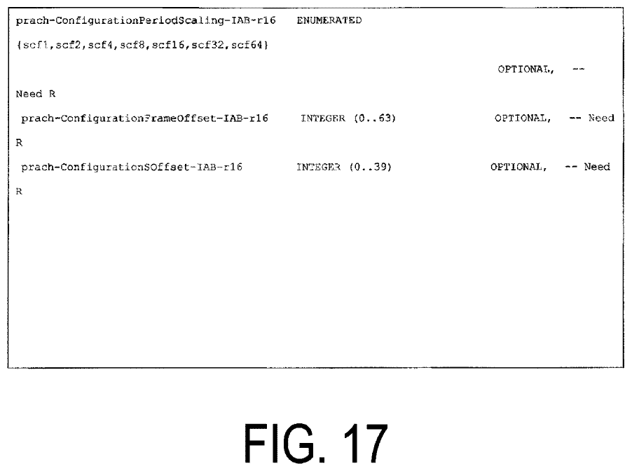

### DESCRIPTION OF EMBODIMENTS

A mobile communication system according to an embodiment is described with reference to the drawings. In the description of the drawings, the same or similar parts are denoted by the same or similar reference numerals.

### (1) First Embodiment

A first embodiment will be described first. A relay apparatus according to an embodiment is a repeater apparatus (that is, an NCR apparatus) that can be controlled from a network.

### (1.1) Overview of Mobile Communication System

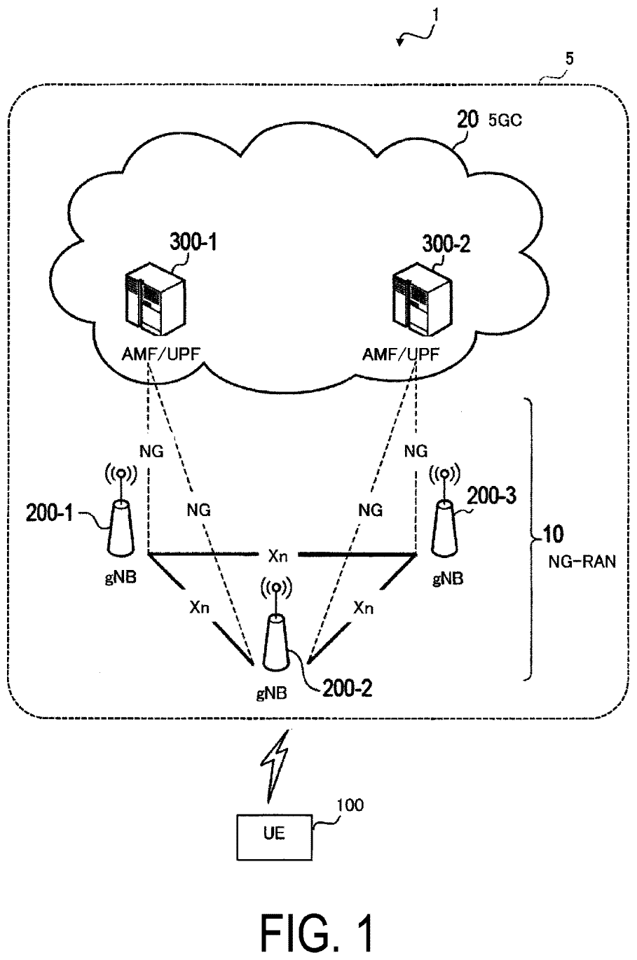

FIG. 1 is a diagram illustrating a configuration of a mobile communication system according to an embodiment.

A mobile communication system 1 complies with the 5th Generation System (5GS) of the 3rd Generation Partnership Project (3GPP) (trade name, the same applies below) standard. The description below takes the 5GS as an example, but a Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 constitute a network 5 of the mobile communication system 1.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Acrial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term indicating a minimum unit of a wireless communication area. The “cell” is also used as a term indicating a function or a resource for performing wireless communication with the UE 100. One cell belongs to one carrier frequency (hereinafter, simply referred to as a “frequency”).

The gNB 200 may be functionally divided into a Central Unit (CU) and a Distributed Unit (DU). The CU controls the DU. The CU is a unit including upper layers included in a protocol stack described below, such as an RRC layer, an SDAP layer, and a PDCP layer, for example. The CU is connected to a core network via an NG interface which is a backhaul interface. The CU is connected to a neighboring base station via the Xn interface, which is an inter-base station interface. The DU forms a cell. The DU 202 is a unit including lower layers included in the protocol stack described below, such as an RLC layer, a MAC layer, and a PHY layer, for example. The DU is connected to the CU via an Fl interface which is a fronthaul interface.

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

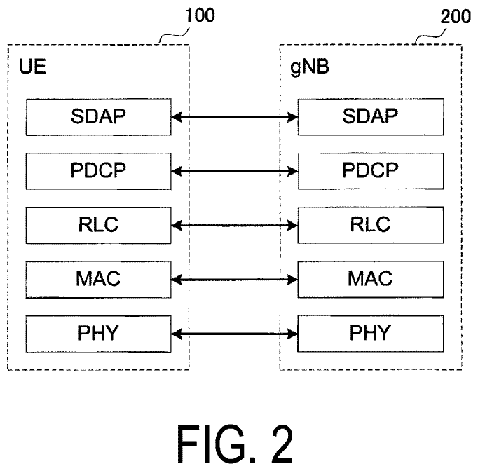

FIG. 2 is a diagram illustrating a configuration of a protocol stack of a wireless interface of a user plane handling data.

A wireless interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of PDCCH using a radio network temporary identifier (RNTI) and acquires successfully decoded DCI as DCI addressed to the UE. CRC bits scrambled by the RNTI are added to the DCI transmitted from the gNB 200.

The gNB 200 transmits a synchronization signal block (Synchronization Signal/PBCH block (SSB)). For example, the SSB includes four consecutive Orthogonal Frequency Division Multiplex (OFDM) symbols, and a primary synchronization signal (PSS), a secondary synchronization signal (SSS), a physical broadcast channel (PBCH)/master information block (MIB), and a demodulation reference signal (DMRS) of the PBCH are disposed. A bandwidth of the SSB is, for example, a bandwidth of 240 consecutive subcarriers, that is, 20RB.

The MAC layer performs priority control of data, retransmission processing through hybrid ARQ (Hybrid Automatic Repeat reQuest (HARQ)), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer uses the functions of the MAC layer and the PHY layer to transmit data to the RLC layer on the receiving side. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that when the RAN is connected to an EPC, the SDAP is not necessary.

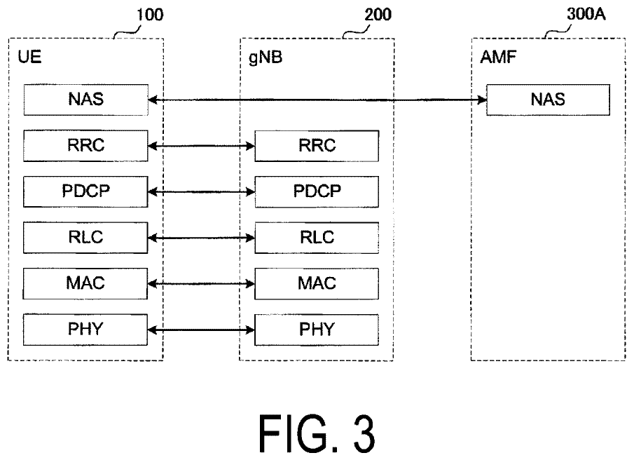

FIG. 3 is a diagram illustrating a configuration of a protocol stack of a wireless interface of a control plane handling signaling (a control signal).

The protocol stack of the wireless interface of the control plane includes a Radio Resource Control (RRC) layer and a Non-Access Stratum (NAS) layer instead of the SDAP layer illustrated in FIG. 2.

RRC signaling for various configurations is transmitted between the RRC layer of the UE 100 and the RRC layer of the gNB 200. The RRC layer controls the logical channel, the transport channel, and the physical channel according to the establishment, re-establishment and release of radio bearers. When a connection (RRC connection) between the RRC of the UE 100 and the RRC of the gNB 200 is present, the UE 100 is in an RRC connected mode. When no connection (RRC connection) between the RRC of the UE 100 and the RRC of the gNB 200 is present, the UE 100 is in an RRC idle mode. When the connection between the RRC of the UE 100 and the RRC of the gNB 200 is suspended, the UE 100 is in an RRC inactive mode.

The NAS layer, which is located above the RRC layer, performs session management, mobility management, and the like. NAS signaling is transmitted between the NAS layer of the UE 100 and the NAS layer of an AMF 300A. Note that the UE 100 has an application layer and the like in addition to the wireless interface protocol. A layer lower than the NAS layer is referred to as Access Stratum (AS).

### (1.2) Example of Application Scenario of Relay Apparatus

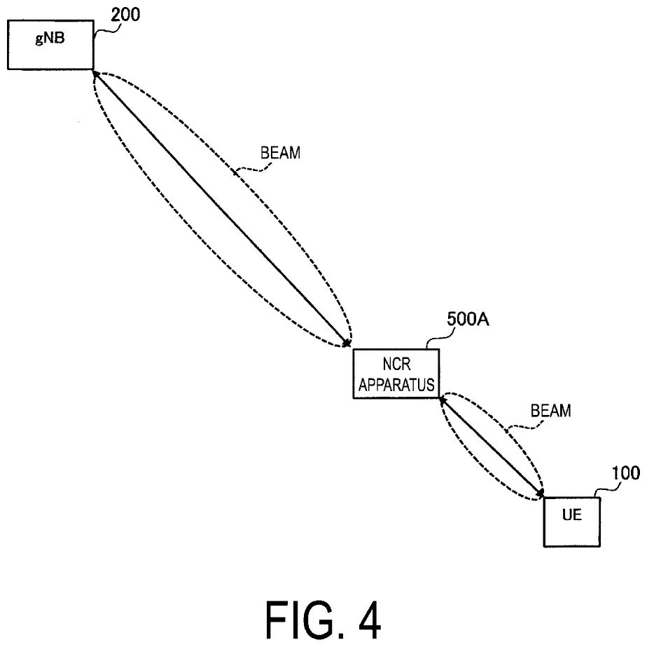

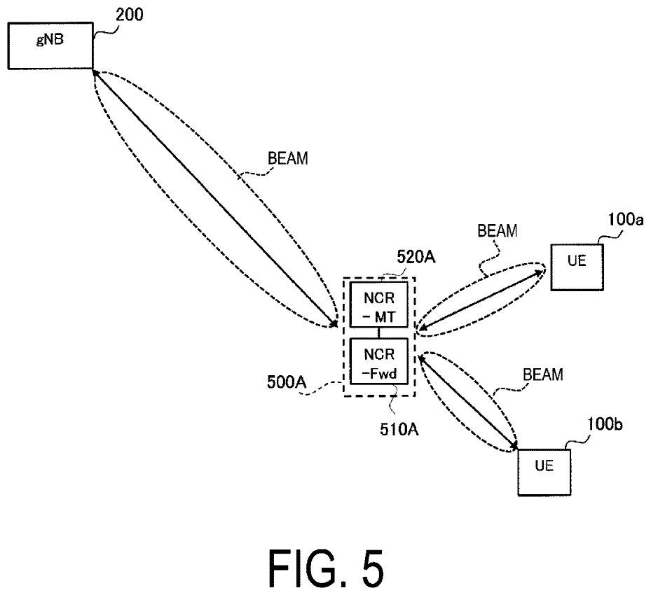

Each of FIGS. 4 and 5 is a diagram illustrating an example of an application scenario of an NCR apparatus according to the embodiment.

The 5G/NR is capable of wide-band transmission via a high frequency band compared to the 4G/LTE. Since radio signals in the high frequency band such as a millimeter wave band or a terahertz wave band have high rectilinearity, a problem is reduction of coverage of the gNB 200. In FIG. 4, the UE 100 may be located outside a coverage area of the gNB 200, for example, outside an area where the UE 100 can receive radio signals directly from the gNB 200. The UE 100 may not communicate with the gNB 200 within a line of sight because of obstacles existing between the gNB 200 and the UE 100.

As illustrated in FIG. 4, an NCR apparatus 500A that can be controlled from a network 5 is introduced into the mobile communication system 1. The NCR apparatus 500A is a repeater apparatus (500A) that is a type of relay apparatus for relaying a radio signal between the gNB 200 and the UE 100. Such a repeater apparatus may be called a smart repeater apparatus.

For example, the NCR apparatus 500A amplifies a radio signal (radio wave) received from the gNB 200 and transmits the radio signal through directional transmission. Specifically, the NCR apparatus 500A receives a radio signal transmitted by the gNB 200 through beamforming. The NCR apparatus 500A amplifies the received radio signal without demodulation and modulation and transmits the amplified radio signal through the directional transmission. Here, the NCR apparatus 500A may transmit the radio signal with a fixed directivity (beam). The NCR apparatus 500A may transmit a radio signal with a variable (adaptive) directional beam. This can efficiently extend the coverage of the gNB 200.

Also, as illustrated in FIG. 5, a new UE (hereinafter referred to as “NCR-MT (Mobile termination)”) 100B, which is a type of control terminal for controlling the NCR apparatus 500A, is introduced. That is, the NCR apparatus 500A includes an NCR-Fwd (Forward) 510A, which is a type of a relay device that relays a radio signal transmitted between the gNB 200 and the UE 100, specifically, changes a propagation state of the radio signal without demodulating or modulating the radio signal, and an NCR-MT 520A that performs wireless communication with the gNB 200 to control the NCR-Fwd 510A.

Thus, the NCR-MT 520A controls the NCR apparatus 500A in cooperation with the gNB 200 by establishing a wireless connection to the gNB 200 and performing wireless communication to the gNB 200. Accordingly, efficient coverage extension can be realized using the NCR apparatus 500A. The NCR-MT 520A controls the NCR apparatus 500A according to control from the gNB 200. The NCR-MT 520A also has the same function as that of the UE 100.

The NCR-MT 520A may be configured separately from the NCR-Fwd 510A. For example, the NCR-MT 520A may be located near the NCR-Fwd 510A and may be electrically connected to the NCR-Fwd 510A. The NCR-MT 520A may be connected to the NCR-Fwd 510A by wire or wireless. Alternatively, the NCR-MT 520A may be configured integrally with the NCR-Fwd 510A. The NCR-MT 520A and the NCR-Fwd 510A may be fixedly installed at a coverage edge (cell edge) of the gNB 200, or on a wall surface or window of any building, for example. The NCR-MT 520A and the NCR-Fwd 510A may be installed, for example, in a vehicle or the like and may be mobile. One NCR-MT 520A may control the plurality of NCR-Fwds 510A.

The configuration is not limited to a configuration in which the NCR-MT 520A directly controls one or more NCR-Fwds 510A, and may be configuration in which the NCR-MT 520A indirectly controls one or more NCR-Fwds 510A. For example, the NCR-MT 520A may control one or more NCR-Fwds 510A via an upper layer (for example, an application layer).

In the example illustrated in FIG. 5, the NCR apparatus 500A (NCR-Fwd 510A) dynamically or semi-statically changes a beam to be transmitted or received. For example, the NCR-Fwd 510A forms a beam toward each of a UE 100a and a UE 100b. The NCR-Fwd 510A may also form a beam toward the gNB 200. For example, in a communication resource between the gNB 200 and the UE 100a, the NCR-Fwd 510A transmits a radio signal received from the gNB 200 toward the UE 100a through beamforming and/or transmits a radio signal received from the UE 100a toward the gNB 200 through beamforming. In a communication resource between the gNB 200 and the UE 100b, the NCR-Fwd 510A transmits the radio signal received from the gNB 200 toward the UE 100b through beamforming and/or transmits the radio signal received from the UE 100b toward the gNB 200 through beamforming. Instead of or in addition to the beam forming, the NCR-Fwd 510A may perform null forming (so-called null steering) toward the UE 100 which is not a communication partner (not illustrated) and/or a neighboring gNB 200 (not illustrated) to curb interference.

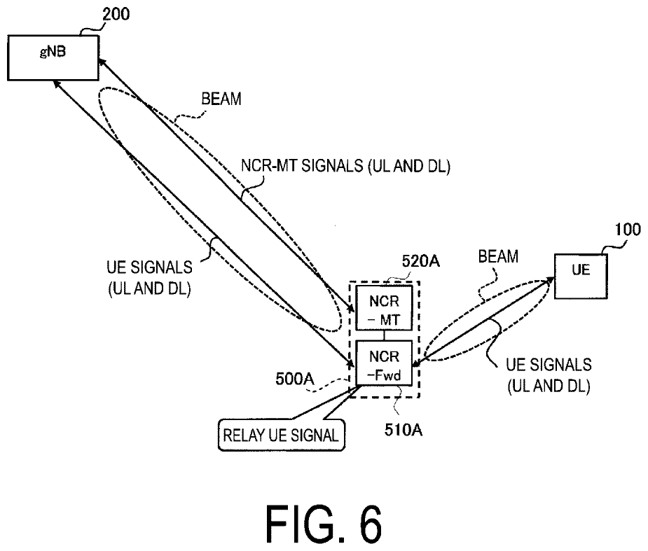

FIG. 6 is a diagram illustrating an example of a control method for the NCR apparatus 500A according to the embodiment.

The NCR-Fwd 510A relays a radio signal (also referred to as “UE signal”) between the gNB 200 and the UE 100. The UE signal includes an uplink signal transmitted from the UE 100 to the gNB 200 (referred to as “UE-UL signal”) and a downlink signal transmitted from the gNB 200 to the UE 100 (referred to as “UE-DL signal”). The NCR-Fwd 510A relays the UE-UL signal from the UE 100 to the gNB 200 and relays the UE-DL signal from the gNB 200 to the UE 100. The radio link between the NCR-Fwd 510A and the UE 100 is also referred to as an “access link”. The radio link between the NCR-Fwd 510A and the gNB 200 is also referred to as a “backhaul link”.

The NCR-MT 520A transmits and receives a radio signal (herein referred to as an “NCR-MT signal”) to and from the gNB 200. The NCR-MT signal includes an uplink signal transmitted from the NCR-MT 520A to the gNB 200 (referred to as an “NCR-MT-UL signal”), and a downlink signal transmitted from the gNB 200 to the NCR-MT 520A (referred to as an “NCR-MT-DL signal”). The NCR-MT-DL signal includes signaling for controlling the NCR apparatus 500A (for example, an NCR control signal). A radio link between the NCR-MT 520A and the gNB 200 is also referred to as a “control link”.

The gNB 200 directs a beam to the NCR-MT 520A based on the NCR-MT-UL signal from the NCR-MT 520A. Since the NCR apparatus 500A and the NCR-MT 520A are co-located, the beam is also eventually directed to the NCR-Fwd 510A when the backhaul link and the control link have the same frequency and the gNB 200 directs a beam to the NCR-MT 520A. The gNB 200 transmits the NCR-MT-DL signal and the UE-DL signal using the beam. The NCR-MT 520A receives the NCR-MT-DL signal. When the NCR-Fwd 510A and the NCR-MT 520A are at least partially integrated, a function (for example, antennas) for transmitting or receiving, or relaying UE signals and/or NCR-MT signals may be integrated in the NCR-Fwd 510A and the NCR-MT 520A. The beam includes a transmission beam and/or a reception beam. The beam is a general term for transmission and/or reception under control for maximizing power of a transmission wave and/or a reception wave in a specific direction by adjusting/adapting an antenna weight or the like.

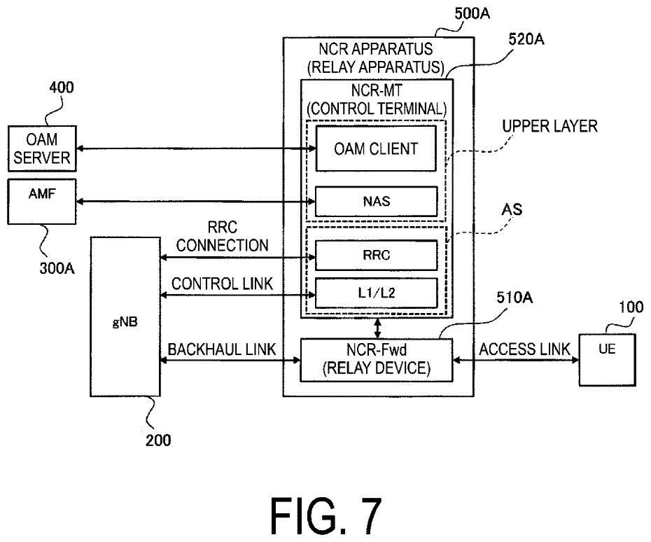

FIG. 7 is a diagram for describing an example of a configuration of a protocol stack in the NCR apparatus 500A according to the embodiment.

The NCR-Fwd 510A relays a radio signal transmitted and received between the gNB 200 and the UE 100. The NCR-Fwd 510A has a Radio Frequency (RF) function of amplifying and relaying a received radio signal, and performs directional transmission through beamforming (for example, analog beamforming).

The NCR-MT 520A includes entities of layers of a layer 1 and/or a layer 2 (L1/L2), the RRC, and the NAS. The L1/L2 (in particular, PHY, MAC) of the NCR-MT 520A and the RRC are also referred to as “the AS of the NCR-MT 520A”.

The NCR-MT 520A may include at least one of an Operation, Administration, Maintenance (OAM) client that communicates with an OAM server 400, a NAS layer that communicates with the AMF 300A, and an F1-Application Protocol (AP) layer. The OAM client, the NAS layer, and the F1-AP layer of the NCR-MT 520A are also referred to as “upper layers of the NCR-MT 520A” with reference to the AS of the NCR-MT 520A.

A backhaul link is established between the gNB 200 and the NCR-Fwd 510A. An access link is established between the UE 100 and the NCR-Fwd 510A. The NCR-Fwd 510A relays a radio signal transmitted between the gNB 200 and the UE 100 via the backhaul link and the access link. The NCR-Fwd 510A changes a propagation state of the radio signal without demodulating or modulating the radio signal.

A control link is established between the gNB 200 and the L1/L2 of the NCR-MT 520A. The L1/L2 of the NCR-MT 520A transmits and receives L1/L2 signaling to and from the gNB 200 via the control link. An RRC connection is established between the gNB 200 and the RRC of the NCR-MT 520A. The RRC of the NCR-MT 520A transmits and receives an RRC message to and from the gNB 200 via the RRC connection. The NCR-MT 520A receives downlink signaling (also referred to as an “NCR control signal” or simply “control signal”) from the gNB 200 via the RRC connection and/or the control link.

The gNB 200 (transmitter 210) transmits the NCR control signal to the NCR-MT 520A. The NCR control signal may be an RRC message, which is a control signal of the RRC layer (that is, layer 3). The NCR control signal may be a MAC control element (CE), which is a control signal of the MAC layer (that is, layer 2). The NCR control signal may be downlink control information (DCI), which is a control signal of the PHY layer (that is, layer 1). The

NCR control signal may be UE-specific signaling. The NCR control signal may be broadcast signaling. The NCR control signal may be a fronthaul message (for example, F1-AP message). When the NCR-MT 520A is a type or part of a base station, the NCR-MT 520A may communicate with the gNB 200 via an AP of Xn (Xn-AP), which is an inter-base station interface.

Hereinafter, the NCR control signal transmitted in the RRC message (and/or MAC CE) and used for static or semi-static control of the NCR-Fwd 510A is also referred to as “NCR configuration information” or simply “configuration information”. Such configuration information may be referred to as a “Side Control Configuration”. Here, the RRC message may be an RRC Reconfiguration message. The NCR configuration information includes, for example, information for configuring on/off of the NCR-Fwd 510A. The NCR configuration information may include, for example, information for semi-static beam configuration of the NCR-Fwd 510A.

On the other hand, the NCR control signal transmitted in the L1/L2 signaling, that is, the DCI (and/or MAC CE) and used for dynamic control of the NCR-Fwd 510A is also referred to as “NCR control information” or simply “control information”. The NCR control information may be referred to as “Side Control Information”. Cyclic Redundancy Code (CRC) bits of the PDCCH carrying the NCR control information are scrambled by a newly introduced dedicated RNTI. The dedicated RNTI is also referred to as “NCR-RNTI”. The NCR control information may include, for example, information for dynamic beam control of the NCR-Fwd 510A. The NCR configuration information may include information for instructing dynamic on/off of the NCR-Fwd 510A.

For example, when the NCR-MT 520A is in the RRC connected mode, the NCR apparatus 500A can turn on or off the NCR-Fwd 510A in accordance with the NCR control information received from the gNB 200. On the other hand, after the NCR-MT 520A transitions to the RRC inactive mode, the NCR apparatus 500A can turn on or off the NCR-Fwd 510A in accordance with the latest (last) configuration information received from the gNB 200.

Further, the NCR control signal (for example, NCR configuration information by RRC and/or NCR control information by L1/L2 signaling) held by the NCR apparatus 500A (NCR-MT 520A) may be referred to as an NCR-Fwd context.

Also, when a radio link failure (RLF) with the gNB 200 is detected by the NCR-MT 520A, the NCR-MT 520A executes cell selection and triggers RRC connection re-establishment (also referred to as “RRC re-establishment”). Here, when the NCR-MT 520A enters the RRC idle mode because a suitable cell cannot be found in the cell selection, the NCR apparatus 500A turns off the NCR-Fwd 510A. The NCR-Fwd 510A is off during an RRC connection re-establishment procedure.

The NCR control signal may include frequency control information for designating a center frequency of a radio signal (for example, a component carrier) that is a relay target in the NCR-Fwd 510A. When the NCR control signal received from the gNB 200 includes the frequency control information, the NCR-MT 520A (controller 523) controls the NCR-Fwd 510A such that the NCR-Fwd 510A relays a radio signal whose center frequency is indicated by the frequency control information as a target (step S2A). The NCR control signal may include a plurality of pieces of frequency control information for designating center frequencies different from each other. Since the NCR control signal includes the frequency control information, the gNB 200 can designate the center frequency of the radio signal to be relayed by the NCR-Fwd 510A via the NCR-MT 520A.

The NCR control signal may include mode control information for designating an operation mode of the NCR-Fwd 510A. The mode control information may be associated with the frequency control information (center frequency). The operation mode may be any one of a mode in which the NCR-Fwd 510A performs omnidirectional transmission and/or reception, a mode in which the NCR-Fwd 510A performs fixed-directional transmission and/or reception, a mode in which the NCR-Fwd 510A performs transmission and/or reception with a variable directional beam, and a mode in which the NCR-Fwd 510A performs Multiple Input Multiple Output (MIMO) relay transmission. The operation mode may be either a beamforming mode (that is, a mode in which improvement of a desired wave is emphasized) and a null steering mode (that is, a mode in which curbing of an interference wave is emphasized). When the NCR control signal received from the gNB 200 includes the mode control information, the NCR-MT 520A (controller 523) controls the NCR-Fwd 510A such that the NCR-Fwd 510A operates in the operation mode indicated by the mode control information (step S2A). Since the NCR control signal includes the mode control information, the gNB 200 can designate the operation mode of the NCR-Fwd 510A via the NCR-MT 520A.

Here, a mode in which the NCR apparatus 500A performs omnidirectional transmission and/or reception is a mode in which the NCR-Fwd 510A performs relaying in all directions, and may be referred to as an omni mode. The mode in which the NCR-Fwd 510A performs fixed-directional transmission and/or reception may be a directivity mode achieved by one directional antenna. The mode may be a beamforming mode achieved by applying fixed phase and amplitude control (antenna weight control) to a plurality of antennas. Any of these modes may be designated (set) from the gNB 200 to the NCR-MT 520A. The mode in which the NCR-Fwd 510A performs transmission and/or reception with a variable directional beam may be a mode for performing analog beamforming. The mode may be a mode in which digital beamforming is performed. The mode may be a mode in which hybrid beamforming is performed. The mode may be a mode for forming an adaptive beam specific to the UE 100. Any of these modes may be designated (set) from the gNB 200 to the NCR-MT 520A. In the operation mode in which beamforming is performed, beam control information to be described below may be provided from the gNB 200 to the NCR-MT 520A. The mode in which the NCR apparatus 500A performs MIMO relay transmission may be a mode for performing Single-User (SU) spatial multiplexing. The mode may be a mode for performing Multi-User (MU) spatial multiplexing. The mode may be a mode for performing transmission diversity. Any of these modes may be designated (set) from the gNB 200 to the NCR-MT 520A. The operation mode may include a mode in which relay transmission by the NCR-Fwd 510A is turned on (activated) and a mode in which the relay transmission by the NCR-Fwd 510A is turned off (deactivated). Any of these modes may be designated (set) from the gNB 200 to the NCR-MT 520A in the NCR control signal.

The NCR control signal may include beam control information for designating a transmission direction, a transmission weight, or a beam pattern when the NCR-Fwd 510A performs directional transmission. The beam control information may be associated with the frequency control information (center frequency). The beam control information may include a Precoding Matrix Indicator (PMI). The beam control information may include beam forming angle information. When the NCR control signal received from the gNB 200 includes beam control information, the NCR-MT 520A (controller 523) controls the NCR-Fwd 510A to form a transmission directivity (beam) indicated by the beam control information. When the NCR control signal includes the beam control information, the gNB 200 can control the transmission directivity of the NCR apparatus 500A via the NCR-MT 520A.

The NCR control signal may include output control information for designating a degree to which the NCR-Fwd 510A amplifies the radio signal (amplification gain) or the transmission power. The output control information may be information indicating a difference value (that is, a relative value) between a current amplification gain or transmission power and a target amplification gain or transmission power. When the NCR control signal received from the gNB 200 includes output control information, the NCR-MT 520A (controller 523) controls the NCR-Fwd 510A so that the NCR-Fwd 510A performs change to the amplification gain or transmission power indicated by the output control information. The output control information may be associated with frequency control information (center frequency). The output control information may be information for designating any one of an amplification gain, a beamforming gain, and an antenna gain of the NCR-Fwd 510A. The output control information may be information for designating transmission power of the NCR-Fwd 510A.

When one NCR-MT 520A controls the plurality of NCR-Fwds 510A, the gNB 200 (transmitter 210) may transmit an NCR control signal to the NCR-MT 520A for each NCR-Fwd 510A. In this case, the NCR control signal may include an identifier of the corresponding NCR-Fwd 510A (NCR identifier). The NCR-MT 520A (controller 523) controlling the plurality of NCR-Fwds 510A determines the NCR-Fwd 510A to which the NCR control signal is applied, based on the NCR identifier included in the NCR control signal received from the gNB 200. The NCR identifier may be transmitted together with the NCR control signal from the NCR-MT 520A to the gNB 200 even when the NCR-MT 520A controls only one NCR-Fwd 510A.

Thus, the NCR-MT 520A (controller 523) controls the NCR-Fwd 510A based on the NCR control signal from the gNB 200. This enables the gNB 200 to control the NCR-Fwd 510A via the NCR-MT 520A.

### (1.3) Example of Configuration of Each Apparatus

An example of a configuration of each apparatus in the mobile communication system 1 according to the embodiment will be described.

### (1.3.1) Example of Configuration of Relay Apparatus

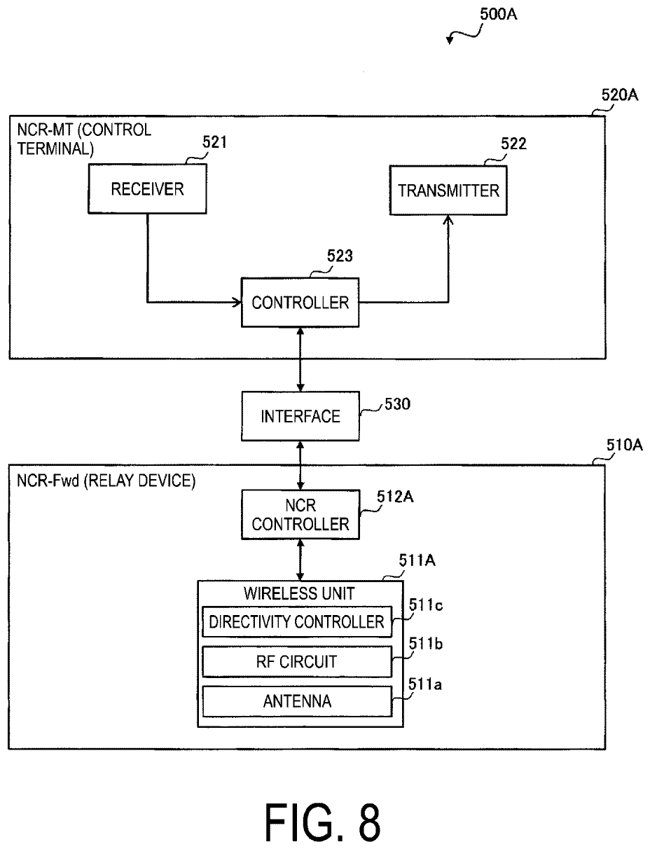

FIG. 8 is a diagram illustrating an example of a configuration of the NCR apparatus 500A (relay apparatus) according to the embodiment. The NCR apparatus 500A includes an NCR-Fwd 510A, an NCR-MT 520A, and an interface 530.

The NCR-Fwd 510A includes a wireless unit 511A and an NCR controller 512A. The wireless unit 511A includes an antenna 511a including a plurality of antennas (a plurality of antenna elements), an RF circuit 511b including an amplifier, and a directivity controller 511c that controls directivity of the antenna 511a. The RF circuit 511b amplifies and relays (transmits) radio signals transmitted and received by the antenna 511a. The RF circuit 511b may convert a radio signal, which is an analog signal, into a digital signal, and reconvert the digital signal into an analog signal after digital signal processing. The directivity controller 511c may perform analog beamforming through analog signal processing. The directivity controller 511c may perform digital beamforming through digital signal processing. The directivity controller 511c may perform analog and digital hybrid beamforming. The NCR controller 512A controls the wireless unit 511A in response to a control signal from the NCR-MT 520A. The NCR controller 512A may include at least one processor.

The NCR-MT 520A includes a receiver 521, a transmitter 522, and a controller 523. The receiver 521 performs various types of reception under control of the controller 523. The receiver 521 includes an antenna and a reception device. The reception device converts a radio signal received by the antenna (radio signal) into a baseband signal (a reception signal) and outputs the reception signal to the controller 523. The transmitter 522 performs various types of transmission under control of the controller 523. The transmitter 522 includes an antenna and a transmission device. The transmission device converts a baseband signal (a transmission signal) output by the controller 523 into a radio signal and transmits the radio signal from the antenna. The controller 523 performs various types of controls in the NCR-MT 520A. The operation of the NCR-MT 520A (and the NCR apparatus 500A) described above and to be described below may be an operation controlled by the controller 523. The controller 523 includes at least one processor and at least one memory. The memory stores programs executed by the processor and information used in processing by the processor. The processor may include a baseband processor and a Central Processing Unit (CPU). The baseband processor performs modulation/demodulation and encoding/decoding of the baseband signal. The CPU executes programs stored in the memory to perform various processes. The controller 523 executes a function of at least one layer selected from the group consisting of the PHY, the MAC, the RRC, and the F1-AP.

The interface 530 electrically or logically connects the NCR-Fwd 510A and the NCR-MT 520A. The controller 523 of the NCR-MT 520A controls the NCR-Fwd 510A via the interface 530. The interface 530 may be a logical entity of an upper layer (for example, an application layer).

In an embodiment, the receiver 521 of the NCR-MT 520A receives signaling (NCR control signal) used to control the NCR apparatus 500A from the gNB 200 through wireless communication. The controller 523 of the NCR-MT 520A controls the NCR apparatus 500A based on the signaling. This enables the gNB 200 to control the NCR-Fwd 510A via the NCR-MT 520A.

### (1.3.2) Example of Configuration of User Equipment

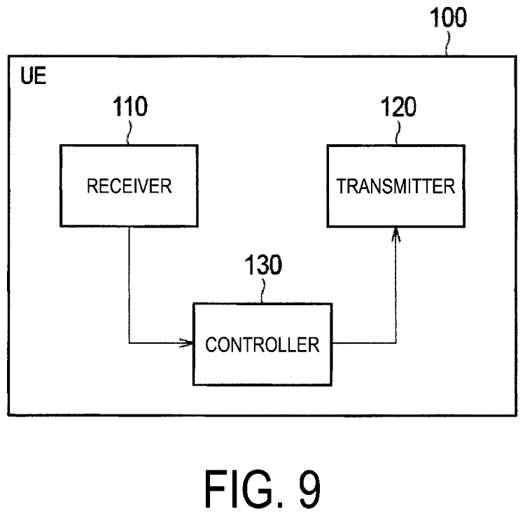

FIG. 9 is a diagram illustrating a configuration of the UE 100 (user equipment) according to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under the control of the controller 130. The receiver 110 includes an antenna and a reception device. The reception device converts a radio signal received by the antenna into a baseband signal (a reception signal) and outputs the resulting signal to the controller 130.

The transmitter 120 performs various types of transmission under the control of the controller 130. The transmitter 120 includes an antenna and a transmission device. The transmission device converts a baseband signal (a transmission signal) output by the controller 130 into a radio signal and transmits the resulting signal from an antenna.

The controller 130 performs various controls and processes in the UE 100. Such processing includes processing of respective layers to be described below. The operations of the UE 100 described above and to be described below may be operations under the control of the controller 130. The controller 130 includes at least one processor and at least one memory. The memory stores programs executed by the processor and information used in processing by the processor. The processor may include a baseband processor and a CPU. The baseband processor performs modulation/demodulation and encoding/decoding of the baseband signal. The CPU executes programs stored in the memory to perform various processes.

### (1.3.3) Example of Configuration of Base Station

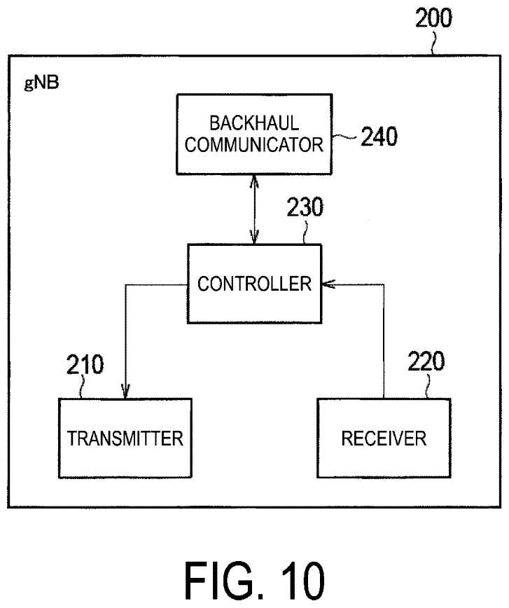

FIG. 10 is a diagram illustrating an example of a configuration of the gNB 200 (base station) according to the embodiment. The gNB 200 includes a transmitter 210, a receiver 220, a controller 230, and a backhaul communicator 240.

The transmitter 210 performs various types of transmission under the control of the controller 230. The transmitter 210 includes an antenna and a transmission device. The transmission device converts a baseband signal (a transmission signal) output by the controller 230 into a radio signal and transmits the resulting signal from an antenna. The receiver 220 performs various types of reception under the control of the controller 230. The receiver 220 includes an antenna and a reception device. The reception device converts a radio signal received by the antenna into a baseband signal (a reception signal) and outputs the resulting signal to the controller 230. The transmitter 210 and the receiver 220 may be capable of beamforming using a plurality of antennas.

The controller 230 performs various types of control for the gNB 200. The operations of the gNB 200 described above and to be described below may be also performed under the control of the controller 230. The controller 230 includes at least one processor and at least one memory. The memory stores programs executed by the processor and information used in processing by the processor. The processor may include a baseband processor and a CPU. The baseband processor performs modulation/demodulation and encoding/decoding of the baseband signal. The CPU executes programs stored in the memory to perform various processes.

The backhaul communicator 240 is connected to a neighboring base station via the inter-base station interface. The backhaul communicator 240 is connected to the AMF/UPF 300 via the interface between a base station and the core network. The gNB may include a Central Unit (CU) and a Distributed Unit (DU) (that is, functions are divided), and both units may be connected via an Fl interface.

In the embodiment, the transmitter 210 of the gNB 200 transmits signaling (NCR control signal) used for control of the NCR-Fwd 510A to the NCR-MT 520A through wireless communication. This enables the gNB 200 to control the NCR apparatus 500A via the NCR-MT 520A.

### (1.4) Overview of Cell Reselection

The NCR-MT 520A supports cell reselection in the RRC idle mode or the RRC inactive mode.

Hereinafter, the NCR-MT 520A “camped on a cell” means that the NCR-MT 520A has completed cell selection/reselection processing and has selected a cell, and the NCR-MT 520A monitors system information and paging. Further, “serving cell” of the NCR-MT 520A refers to a cell on which the NCR-MT 520A camps.

### (1.4.1) Cell Reselection Procedure

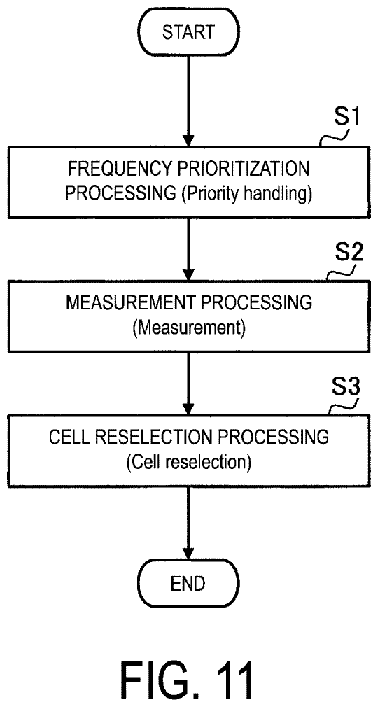

FIG. 11 is a diagram for describing a typical cell reselection procedure (also referred to as a “cell reselection procedure in the past”). The NCR-MT 520A in the RRC idle mode or the RRC inactive mode performs the cell reselection procedure to move from a current serving cell to a neighboring cell. In particular, the NCR-MT 520A specifies the neighboring cell to camp on by itself through a cell reselection procedure and reselects the specified neighboring cell. Note that a case that the current serving cell and the neighboring cell have the same frequency (carrier frequency) is referred to as an intra-frequency, and a case that the current serving cell and the neighboring cell have different frequencies (carrier frequencies) is referred to as an inter-frequency. The current serving cell and the neighboring cell may be managed by the same gNB 200. The serving cell and the neighboring cell may be managed by the gNBs 200 different from each other.

In step S1, NCR-MT 520A performs frequency prioritization processing based on the priority (also referred to as “absolute priority”, “cell reselection priority”, or “dedicated priority”) for each frequency specified by the gNB 200 with, for example, a system information block (SIB) or an RRC Release message. Specifically, the NCR-MT 520A manages the frequency priority specified by the gNB 200 for each frequency.

In step S2, the NCR-MT 520A performs measurement processing of measuring radio qualities of the serving cell and the neighboring cell, respectively. The NCR-MT 520A measures received power and reception quality of a reference signal, specifically, a Cell Defining-Synchronization Signal and PBCH block (CD-SSB) transmitted by each of the serving cell and the neighboring cell. For example, the NCR-MT 520A always measures the radio quality for a frequency having a priority higher than the priority of the frequency of the current serving cell, and for a frequency having a priority equal to or lower than the priority of the frequency of the current serving cell, measures the radio quality of a frequency having an equal or lower priority when the radio quality of the current serving cell becomes lower than the predetermined quality. Although an example in which reference signal received power (RSRP) is used as the radio quality will mainly be described below, the radio quality may include reference signal reception quality (RSRQ) in addition to or instead of the RSRP.

In step S3, the NCR-MT 520A performs a cell reselection processing of reselecting the cell to which the NCR-MT 520A itself camps on based on a measurement result in step S2. For example, when the priority of the frequency of the neighboring cell is higher than the priority of the current serving cell and the neighboring cell satisfies a predetermined quality criterion (that is, the required minimum quality criterion) for a predetermined period, the NCR-MT 520A may perform cell reselection to the neighboring cell. When the priority of the frequency of the neighboring cell is the same as the priority of the current serving cell, the NCR-MT 520A may rank the radio quality of the neighboring cell and perform cell reselection to the neighboring cell having a rank higher than the rank of the current serving cell for a predetermined period of time. When the priority of the frequency of the neighboring cell is lower than the priority of the current serving cell, and a state continues for a predetermined period, the state in which the radio quality of the current serving cell is lower than a certain threshold value and the radio quality of the neighboring cell is higher than another threshold value, the NCR-MT 520A may perform cell reselection to the neighboring cell.

### (1.4.2) Cell Category

Cells are categorized into “acceptable cell”, “suitable cell”, “barred cell”, and “reserved cell” in accordance with the service provided.

The acceptable cell is a cell on which the NCR-MT 520A can camp to obtain a limited service. The limited service includes the origination of an Emergency call (outgoing call) and the reception of an Earthquake and Tsunami Warning System (ETWS)/Commercial Mobile Alert System (CMAS) notification. The acceptable cell needs to satisfy the following two conditions:
Not a barred cell in which an access is restrained, and
A predetermined quality criterion (cell selection criterion) is satisfied. Note that the barred cell is indicated by the system information. The reserved cell is also indicated by the system information.

The suitable cell is a cell on which the NCR-MT 520A can camp to obtain normal services without limitations described above. The acceptable cell needs to satisfy the following conditions:

Being a cell of a selected Public Land Mobile Network (PLMN), a registered PLMN, or an equivalent PLMN,
A predetermined quality criterion (cell selection criterion) is satisfied,
Not a barred cell in which an access is restrained, and
Not a cell in a forbidden tracking area.

### (1.4.3) Cell Selection State

The cell selection state of the NCR-MT 520A includes a Camped normally state, an Any cell selection state, and a Camped on any cell state.

The Camped normally state is applied to the RRC idle mode and the RRC inactive mode. The NCR-MT 520A in the Camped normally state performs monitoring of a paging channel, monitoring of a short message on a DCI, monitoring of system information, measurement and evaluation in cell reselection, and the like.

The Any cell selection state is applied to the RRC idle mode and the RRC inactive mode. In this state, the NCR-MT 520A performs cell selection and finds a suitable cell. The NCR-MT 520A, which is not camped on any cell, remains in this state.

The Camped on any cell state is applied only to the RRC idle mode. The NCR-MT 520A in the Camped on any cell state performs monitoring of a paging channel, monitoring of a short message on a DCI, monitoring of system information, measurement and evaluation in cell reselection, and the like. In this state, the NCR-MT 520A tries all frequencies of all RATs supported and tries to find a suitable cell. When a suitable cell is found, the NCR-MT 520A transitions to the Camped normally state.

### (1.5) Operation According to First Embodiment

In the first embodiment, a scenario is assumed that the NCR-MT 520A in the RRC connected mode selects not a suitable cell but an acceptable cell, after receiving the RRC Release including a suspend configuration from the gNB 200 and transitioning to the RRC inactive mode.

When having selected (reselected) an acceptable cell, the NCR-MT 520A in the RRC inactive mode transitions to the RRC idle mode. Specifically, first, the NCR-MT 520A that has transitioned to the RRC inactive mode cannot find a suitable cell in cell selection and/or cell reselection (no suitable cell found), and enters the Any cell selection state. Second, the NCR-MT 520A in the Any cell selection state in the RRC inactive mode finds an acceptable cell, transitions to the RRC idle mode, and enters the Camped on any cell state. As described above, in the first embodiment, it is mainly assumed that the NCR-MT 520A spontaneously (automatically) transitions from the RRC inactive mode to the RRC idle mode.

Here, the gNB 200 cannot start paging for the NCR-MT 520A in the RRC idle mode. Hence, the gNB 200 cannot cause the NCR-MT 520A in the RRC idle mode to transition to the RRC connected mode by paging. Thus, it is hard for the gNB 200 to provide new NCR configuration information to the NCR-MT 520A that has transitioned to the RRC idle mode.

Specifically, when the gNB 200 causes the NCR-MT 520A to transition to the RRC inactive mode, under normal circumstances the gNB 200 can freely cause the NCR-MT 520A to transition to the RRC connected mode by RAN paging. However, when the NCR-MT 520A spontaneously transitions to the RRC idle mode, there arises a state in which the gNB 200 cannot manage/control the NCR-MT 520A.

### (1.5.1) First Operation Pattern

In the first operation pattern of the first embodiment, it is assumed that the NCR-MT 520A in the RRC idle mode that camps on an acceptable cell selects (reselects) a suitable cell in which a normal service is provided. In this case, since the NCR-MT 520A has spontaneously transitioned to the RRC idle mode, it is desired that the NCR-MT 520A transitions to the RRC connected mode by spontaneously performing the RRC connection establishment procedure. In the first operation pattern, there will be described an operation that enables such spontaneous initiation of the RRC connection establishment procedure.

In the first operation pattern, the NCR-MT 520A in the RRC idle mode camps on a suitable cell. The NCR-MT 520A in the RRC idle mode initiates the RRC connection establishment procedure to transition to the RRC connected mode based on having camped on a suitable cell. For example, when having found a suitable cell, having selected (reselected) a suitable cell, having camped on a suitable cell, or having entered the Camped normally state, the NCR apparatus 500A in the RRC idle mode spontaneously initiates the RRC connection establishment procedure. When having camped on a suitable cell by moving from outside of the service area to inside of the service area or having camped on a suitable cell at a time of switching from power OFF to power ON, the NCR-MT 520A may spontaneously initiate the RRC connection establishment procedure.

In the first operation pattern, the NCR-MT 520A in the RRC idle mode may initiate the RRC connection establishment procedure in response to having camped on a suitable cell and the OAM client of the NCR-MT 520A having generated the uplink data. That is, the RRC connection establishment procedure may be initiated by the OAM client generating uplink data (uplink packet). Note that the OAM (the OAM client or the OAM server 400) may be a type of function of the application layer. The application layer may be an upper layer than the AS layer and the NAS layer.

In the first operation pattern, the NCR-MT 520A in the RRC idle mode may initiate the RRC connection establishment procedure in response to having camped on a suitable cell and having received a request from the NAS of the NCR-MT 520A to the AS of the NCR-MT 520A. For example, after the AS of the NCR-MT 520A notifies the NAS of the NCR-MT 520A, the RRC connection establishment procedure may be initiated in response to a request from the NAS of the NCR-MT 520A.

In the first operation pattern, in response to the NCR-MT 520A in the RRC idle mode having camped on a suitable cell, the AS of the NCR-MT 520A may spontaneously initiate the RRC connection establishment procedure. That is, the AS of the NCR-MT 520A may spontaneously initiate the RRC connection establishment procedure.

In the first operation pattern, when having transitioned to the RRC idle mode by receiving the RRC Release message, the NCR-MT 520A in the RRC idle mode may not initiate the spontaneous RRC connection establishment procedure. This is because, when the gNB 200 intentionally causes the NCR-MT 520A to transition to the RRC idle mode, the probability that the gNB 200 is willing to manage/control the NCR-MT 520A is considered to be low. Specifically, first, the NCR-MT 520A receives an RRC Release message for causing the NCR-MT 520A to transition to the RRC idle mode from the network 5, and transitions to the RRC idle mode in response to receiving the RRC Release message. Second, when having transitioned to the RRC idle mode in response to receiving an RRC Release message, the NCR-MT 520A controls so as not to initiate the RRC connection establishment procedure even when camping on a suitable cell.

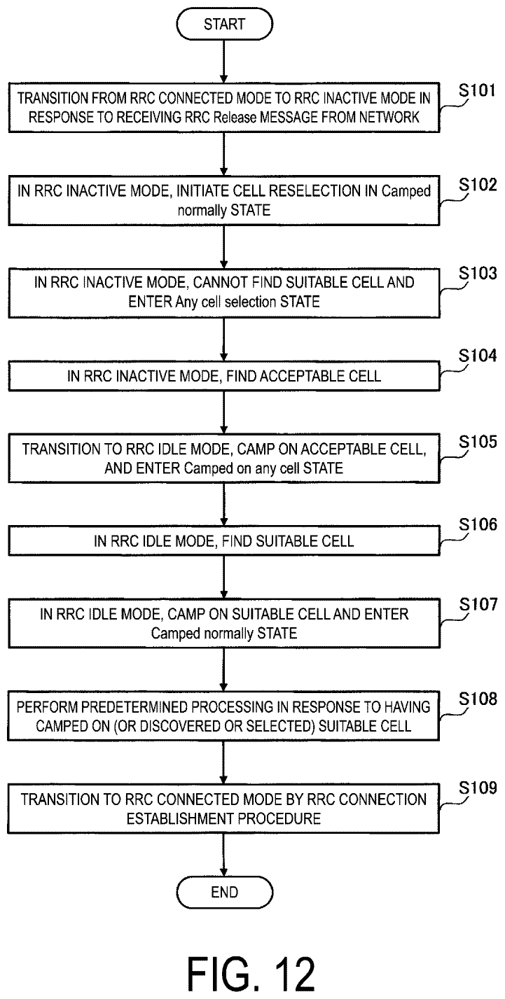

FIG. 12 is a diagram illustrating an example of an operation of the NCR-MT 520A according to the first operation pattern of the first embodiment.

In step S101, the NCR-MT 520A transitions from the RRC connected mode to the RRC inactive mode in response to receiving the RRC Release message from the network 5 (gNB 200).

In step S102, the NCR-MT 520A in the RRC inactive mode performs a cell reselection processing in the Camped normally state. Note that (initial) cell selection processing may be performed.

In step S103, the NCR-MT 520A in the RRC inactive mode cannot find a suitable cell and enters the Any cell selection state. Here, the cell selection processing may be performed.

In step S104, the NCR-MT 520A in the RRC inactive mode finds an acceptable cell.

In step S105, the NCR-MT 520A transitions from the RRC inactive mode to the RRC idle mode, camps on the acceptable cell, and enters the Camped on any cell state.

In step S106, the NCR-MT 520A in the RRC idle mode performs a cell selection (reselection) processing to find a suitable cell.

In step S107, the NCR-MT 520A in the RRC idle mode camps on the suitable cell and enters the Camped normally state. Note that the cell selection (reselection) in step S106 may be initial cell selection at the time of PLMN selection/initial access. In this case, the NCR-MT 520A enters the RRC idle mode for the first time, and this may be used as a trigger for the subsequent processing.

In step S108, the NCR-MT 520A in the RRC idle mode performs any operation/processing of the following A) to C) in response to having camped on (or found or selected) the suitable cell.

A) When the OAM client generates uplink data (OAM traffic):
First, the AS of the NCR-MT 520A notifies the OAM client of having camped on (or discovered or selected) a suitable cell. The notification may be a notification indicating that an outgoing call has become possible or a notification indicating requesting an outgoing call. Note that the notification may be notified from the AS of the NCR-MT 520A to the NAS of the NCR-MT 520A, and may be notified from the NAS to the OAM client;
Second, the OAM client generates OAM traffic for the OAM server 400. For example, the OAM traffic may be a message notifying that the NCR apparatus 500A has successfully connected to the network coverage;
Third, the OAM client passes the OAM traffic (uplink packets) to the lower layer;
Fourth, having received the uplink packet, the NAS of the NCR-MT 520A requests the lower layer (the AS of the NCR-MT 520A) to establish an RRC connection. As a result, the AS of the NCR-MT 520A transmits an RRC Setup Request message to the suitable cell (gNB 200).

B) When the NAS of the NCR-MT 520A requests:
First, the AS of the NCR-MT 520A notifies the NAS of the NCR-MT 520A of having camped on (or discovered or selected) a suitable cell, a request for performing RRC connection (or performing an outgoing call), or a UE-ID in the NCR-MT 520A (the same as in paging reception);
Second, having received the notification, the NAS of the NCR-MT 520A requests the RRC connection establishment to the lower layer (the AS of the NCR-MT 520A). As a result, the AS of the NCR-MT 520A transmits an RRC Setup Request message to the suitable cell (gNB 200).

C) When the AS of the NCR-MT 520A spontaneously performs:
First, having camped on a suitable cell, the AS of the NCR-MT 520A transmits an RRC Setup Request message to the suitable cell (gNB 200). Note that only when having moved from an acceptable cell to a suitable cell and/or having found (or camped on) a suitable cell by cell selection (not cell reselection), the AS of the NCR-MT 520A may transmit the RRC Setup Request message. That is, when having entered the Camped normally state, the AS of the NCR-MT 520A transmits the message. Alternatively, only when having moved from outside of the service area (Out of coverage), that is, no cell found, to a suitable cell of inside of the service area (In-coverage), the AS of the NCR-MT 520A may transmit the RRC Setup Request message. Note that, when a suitable cell is found (or camped) as a result of cell selection accompanying the exit from the RRC connected mode and/or when having entered the Camped normally state, the AS of the NCR-MT 520A may not transmit the RRC Setup Request message. Alternatively, when the transition to the RRC idle mode is executed by the RRC Release message transmitted by the gNB 200 (that is, when the UE 100 does not automatically transition to the RRC idle mode), the AS of the NCR-MT 520A may not transmit the RRC Setup Request message;
Second, when succeeding in the RRC connection establishment, the AS of the NCR-MT 520A may notify the event to the NAS of the NCR-MT 520A.

In step S109, the NCR-MT 520A transitions to the RRC connected mode. The NCR-MT 520A in the RRC connected mode may receive the NCR configuration information from the gNB 200, for example, in an RRC Reconfiguration message, and may control the NCR-Fwd 510A in accordance with the configuration.

### (1.5.2) Second Operation Pattern

The second operation pattern according to the first embodiment will be described, focusing mainly on differences from the above-described first operation pattern.

In the second operation pattern, it is assumed that the NCR-MT 520A in the RRC idle mode which camps on an acceptable cell cannot select (reselect) a suitable cell in which a normal service is provided and is camping on an acceptable cell. As described above, for an acceptable cell, only limited services, specifically an outgoing call of an Emergency call and reception of ETWS/CMAS, are possible.

The NCR-MT 520A that camps on the acceptable cell, therefore, cannot initiate the RRC connection establishment procedure even when the OAM client generates the uplink data, for example. Thus, for example, when considering the OAM control, since the NCR-MT 520A cannot be connected to the network 5, the NCR-MT 520A cannot be controlled from the OAM server 400.

However, the NCR-MT 520A (NCR apparatus 500A) is considered to be not the UE 100, but a type of a network node. Hence, it may be considered that the NCR-MT 520A (NCR apparatus 500A) can establish the RRC connection in an acceptable cell.

In the second operation pattern, first, the NCR-MT 520A in the RRC idle mode camps on an acceptable cell in which a limited service is provided. Second, the NCR-MT 520A in the RRC idle mode generates the uplink data (for example, OAM traffic) in an acceptable cell. Third, the NCR-MT 520A in the RRC idle mode initiates an RRC connection establishment procedure of transitioning to the RRC connected mode in response to the generated uplink data.

In the RRC connection establishment procedure, the NCR-MT 520A in the RRC idle mode may transmit an RRC Setup Request message including information indicating an Emergency call to an acceptable cell (gNB 200). That is, the NCR-MT 520A (NCR apparatus 500A) attempts, in an acceptable cell, to establish an RRC connection by treating the generated uplink data as an Emergency call.

Specifically, Cause (Establishment Cause) being an information element included in an RRC Setup Request message is information indicating an establishment cause of an RRC connection, and there can be set any value of “emergency”, “highPriorityAccess”, “mt-Access”, “mo-Signaling”, “mo-Data”, “mo-VoiccCall”, “mo-VideoCall”, “mo-SMS”, “mps-Priority Access”, and “mcs-PriorityAccess”. In an acceptable cell, the NCR-MT 520A may transmit an RRC Setup Request message including a Cause set as “emergency”.

In the second operation pattern, in response to the gencrated uplink data and an acceptable cell broadcasting an indicator indicating support of the NCR apparatus 500A (also referred to as “NCR-Supported IE”), the NCR-MT 520A in the RRC idle mode may initiate the RRC connection establishment procedure. When an acceptable cell does not broadcast the NCR-Supported IE in an SIB, the NCR-MT 520A can camp on a cell as the UE 100. The RRC connection establishment procedure as described above, therefore, may be allowed to be initiated only when an acceptable cell broadcasts the NCR-Supported IE. In other words, the initiation of the RRC connection establishment procedure as described above may be performed only when the NCR-MT 520A camps on an acceptable cell not as the UE 100 but as the NCR-MT 520A.

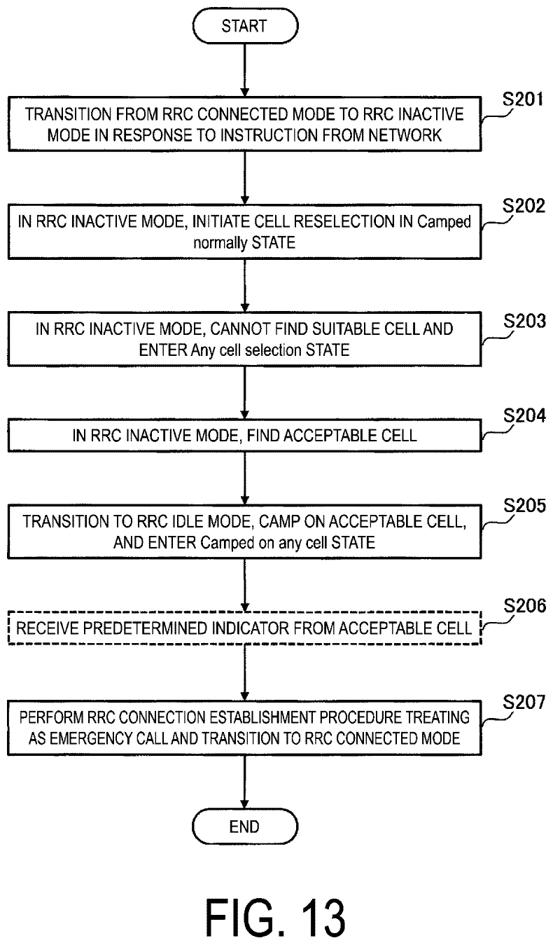

FIG. 13 is a diagram illustrating an example of an operation of the NCR-MT 520A according to the second operation pattern of the first embodiment.

The operations in step S201 to step S203 are the same as those of the first operation pattern described above.

In step S204, the NCR-MT 520A in the RRC idle mode selects (reselects) an acceptable cell. Here, the NCR-MT 520A may perform the processing (step S205) to be described below as a result of having found an acceptable cell, having selected (reselected) an acceptable cell, or having camped on an acceptable cell.

An acceptable cell may be broadcasting the NCR-Supported IE in an SIB 1 (system information block type 1). In this case, the NCR-MT 520A may receive the NCR-Supported IE (S206) and determine that the camping is implemented on the cell as the NCR-MT 520A, not the UE 100. Note that the AS of the NCR-MT 520A may notify the upper layer (for example, the OAM client or the NAS of the NCR-MT 520A) of the camping being implemented on an acceptable cell. In addition, the AS of the NCR-MT 520A may notify the upper layer of receiving the NCR-Supported IE. The AS of the NCR-MT 520A may notify the upper layer that an outgoing call (for example, OAM traffic transmission) of the NCR apparatus 500A is allowed.

In step S207, the NCR-MT 520A in the RRC idle mode initiates the RRC connection establishment procedure. As in the first operation pattern described above, the NCR-MT 520A in the RRC idle mode initiates the RRC connection establishment procedure in response to the upper layer (for example, the OAM client) generating the uplink data, the upper layer (for example, the NAS of the NCR-MT 520A) having made the connection establishment request to the AS of the NCR-MT 520A, or the AS of the NCR-MT 520A spontaneously having triggered the connection establishment request.

In the RRC connection establishment procedure, the AS of the NCR-MT 520A transmits an RRC Setup Request message to the gNB 200. Here, the AS of the NCR-MT 520A sets “emergency call” in the Establishment cause in the RRC Setup Request message. Alternatively, the AS of the NCR-MT 520A may set a new cause value such as “acquisition of NCR configuration information”. Note that “performing access of an NCR apparatus 500” may be additionally defined as a type of service in a Limited service state. That is, a service different from the limited service for the UE 100 may be defined as the limited service for the NCR apparatus. Note that the AS of the NCR-MT 520A may set a cause value specified by the upper layer.

In response to receiving the RRC Setup Request message, the gNB 200 transmits RRC Setup message to the NCR-MT 520A, and with the NCR-MT 520A transmitting an RRC Setup Complete message to the gNB 200, the NCR-MT 520A transitions to the RRC connected mode. This makes it possible, for example, for the OAM client to perform data communication with the OAM server, and for the OAM client to be controlled from the OAM server 400.

However, when the NCR-MT 520A camps on an acceptable cell, the PLMN to which the NCR-MT 520A belongs is considered to be different from the PLMN to which the acceptable cell belongs. Since it may be a problem for the NCR-MT 520A to be able to freely communicate in another PLMN, a limiting mechanism for data communication preferably be provided.

For example, the NCR-MT 520A may initiate the RRC connection establishment procedure in response to, in an acceptable cell, the generated uplink data and the acceptable cell (gNB 200) broadcasting an indicator (for example, “Other PLMN NCR-Supported”) indicating the support of an outgoing call of the NCR apparatus 500A in another PLMN. That is, the gNB 200 may broadcast, in an acceptable cell, permission information (Other PLMN NCR-Supported) of an outgoing call of an NCR apparatus in another PLMN.

The NCR-MT 520A may receive from the network 5 (for example, gNB 200), in an acceptable cell, communication restriction information indicating the content of the communication restriction of an outgoing call of the NCR apparatus 500A. That is, the network 5 may notify the NCR-MT 520A of restriction information (connection permitted time or the like) of a call of the NCR-MT 520A (NCR apparatus 500A) in an acceptable cell. The NCR-MT 520A that has transitioned to the RRC connected mode may perform communication, restricted in accordance with the communication restriction information, with the network 5 (gNB 200).

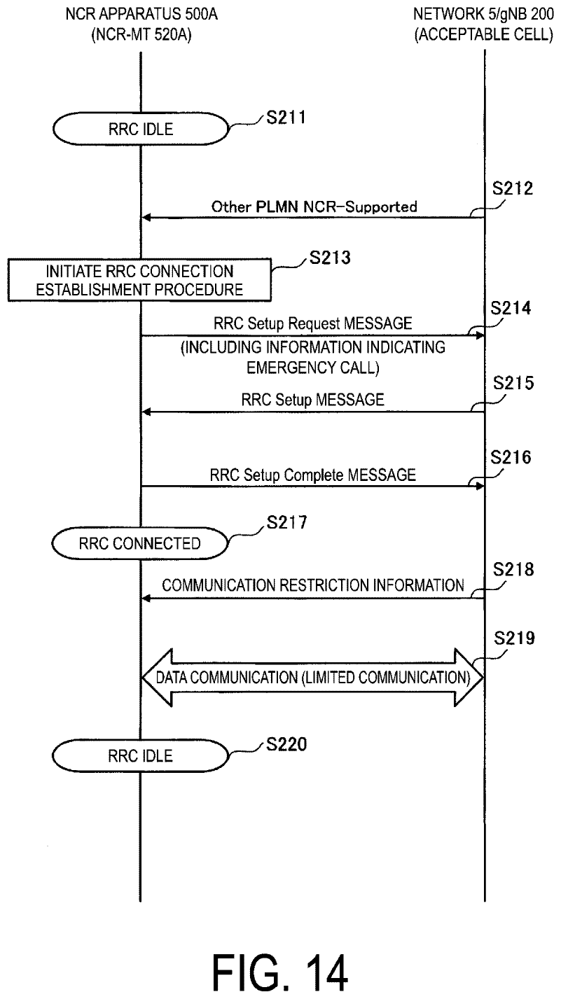

FIG. 14 is a diagram illustrating an example of an operation of the mobile communication system 1 according to the second operation pattern of the first embodiment. The operation in FIG. 14 is performed in combination with the operation in FIG. 13.

In step S211, the NCR-MT 520A is in the RRC idle mode in an acceptable cell (cell of the gNB 200).

In step S212, the gNB 200 broadcasts, in an SIB, permission information of an outgoing call of the NCR-MT 520A (NCR apparatus 500A) in an acceptable cell. The permission information is information that permits the connection of the NCR-MT 520A registered in another PLMN. The permission information may be, for example, 1-bit information of “Other PLMN NCR-Supported”. Alternatively, the gNB 200 may broadcast an ID of the PLMN (may be an ID of a Stand-alone Non-Public Network (SNPN)) to which the NCR apparatus 500A that permits an outgoing call belongs. In this case, an outgoing call can be permitted only for the NCR apparatus 500A that belongs to a specific PLMN. Note that, in the second operation pattern, it is assumed that there is a permission contract between operators of the PLMN to which the acceptable cell belongs and the PLMN to which the NCR apparatus 500A belongs.

When receiving information in step S212 from the camped acceptable cell, the NCR-MT 520A performs the following processing. First, the AS of the NCR-MT 520A notifies the upper layer (NAS of the NCR-MT 520A or the OAM client) being permitted to connect in an acceptable cell and/or the permitted PLMN ID (or SNPN ID). Second, the upper layer executes an outgoing call processing (connection/communication initiation procedure) in response to the notification. Third, the AS of the NCR-MT 520A initiates transmission processing of an RRC Setup Request message (step S213). Here, the cause value in the RRC Setup Request message may be set to “emergency call” (step S214). Then, NCR-MT 520A receives an RRC Setup message from the gNB 200 (step S215), and transmits RRC Setup Complete message to the gNB 200 (step S216), thereby transitioning to the RRC connected mode (step S217).

In step S218, the network 5 transmits communication restriction information of an outgoing call of the NCR apparatus 500A to the NCR-MT 520A. The NCR-MT 520A receives the communication restriction information.

The gNB 200 may broadcast the communication restriction information in the SIB. The gNB 200 may transmit the communication restriction information to the NCR-MT 520A with a dedicated signaling (for example, an RRC Reconfiguration message). Alternatively, the AMF 300A may transmit the communication restriction information to the NCR-MT 520A with the NAS signaling. The AMF 300A may notify the gNB 200 of the communication restriction information by using an NG-AP message, and the gNB 200 may transmit the communication restriction information to the NCR-MT 520A. The communication restriction information notified from the AMF 300A to the gNB 200 may be a QoS parameter corresponding to the limited service. Alternatively, the OAM server 400 may transmit the communication restriction information to the NCR-MT 520A (OAM client) as application data via an IP packet. Note that the communication restriction information may be transmitted from the network 5 to the NCR-MT 520A in advance before step S218.

The communication restriction information includes at least one of a time upper limit (for example, within 10 minutes), a communication amount upper limit (for example, 1 GB or less), an upper limit of the number of sessions (for example, only one protocol data unit (PDU) session, or only a default bearer), a throughput upper limit (for example, 1 Mbps or less), a communication destination restriction (for example, only (IP address of) the OAM server 400), and a communication type restriction (for example, only OAM traffic).

In step S219, the NCR-MT 520A performs only limited communication with the network 5 in accordance with the communication restriction information, and transmits, for example, uplink data generated by the OAM client to the OAM server 400. Here, the upper layer may control communication to perform communication within a range of the communication control information. Alternatively, by controlling communication in the AS of the NCR-MT 520A, communication within the range of the communication control information may be performed. Note that the communication in step S219 may be communication for performing an operation for the NCR apparatus 500A to connect to its own PLMN. In such communication, the OAM server 400 is notified from the OAM client that the connection is made in an acceptable cell, geographical position information of the NCR-MT 520A is notified, or a new configuration (for example, configuration related to cell selection) is performed to the OAM client from the OAM server.

When the communication restriction indicated by the communication restriction information is exceeded (for example, the time upper limit is reached), the communication may be disconnected (transition to the RRC idle mode) under the initiative of the NCR-MT 520A (step S220).

### (2) Second Embodiment

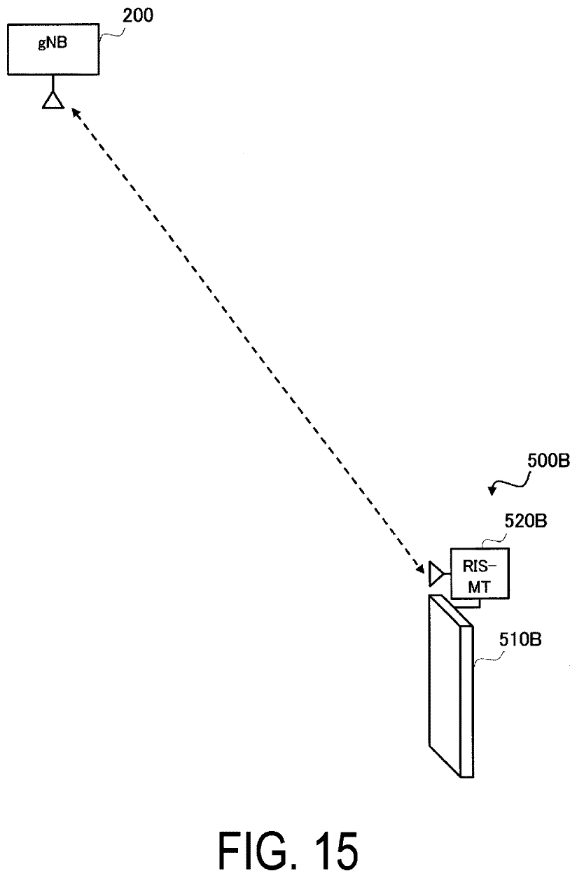

Next, a second embodiment will be described, focusing mainly on differences from the above-described embodiments. As illustrated in FIG. 15, a relay apparatus according to the second embodiment is a Reconfigurable Intelligent Surface (RIS) apparatus 500B that changes a propagation direction of an incident radio wave (radio signal) through reflection or refraction. The “NCR” in the above-described embodiments may be read as the “RIS”.

The RIS is a type of a relay device (hereinafter, also referred to as a “RIS-Fwd”) capable of performing beamforming (directivity control) in a similar way to the NCR by changing the characteristics of metamaterials. The RIS may be able to change a range (distance) of a beam by controlling a reflection direction and/or a refraction direction of each unit element. For example, the RIS may have a configuration capable of controlling the reflection direction and/or refraction direction of each unit element, and focusing on a near UE (directing a beam) or focusing on a far UE (directing a beam).

The RIS apparatus 500B includes a new UE (hereinafter referred to as “RIS-MT”) 520B that is a control terminal for controlling RIS-Fwd 510B. The RIS-MT 520B controls the RIS-Fwd 510B in cooperation with the gNB 200 by establishing a wireless connection to the gNB 200 and performing wireless communication with the gNB 200. The RIS-Fwd 510B may be a reflective RIS. Such an RIS-Fwd 510B reflects an incident radio wave to change a propagation direction of the radio wave. Here, a reflection angle of the radio wave can be variably set. The RIS-Fwd 510B reflects radio waves incident from the gNB 200 toward the UE 100. The RIS-Fwd 510B may be a transmissive RIS. Such an RIS-Fwd 510B refracts an incident radio wave to change the propagation direction of the radio wave. Here, a refraction angle of the radio wave can be variably set.

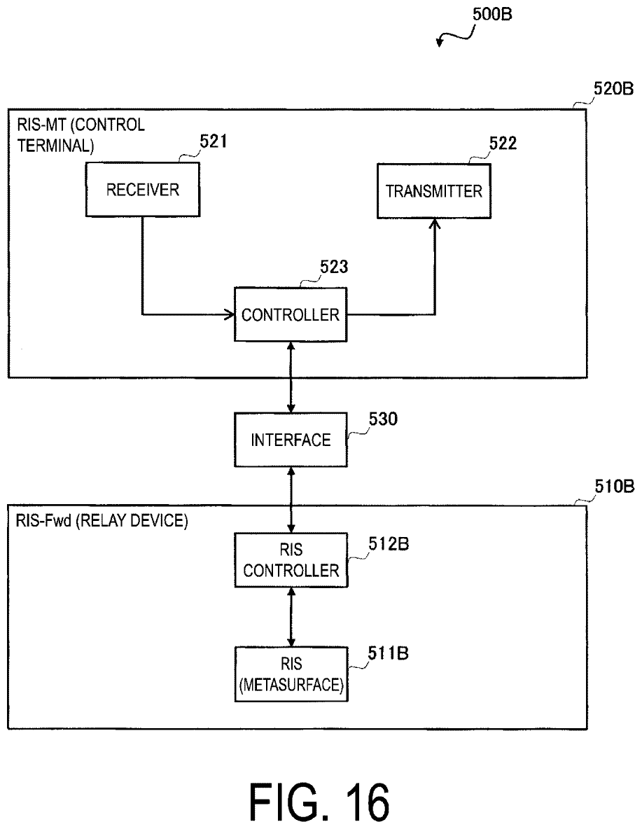

FIG. 16 is a diagram illustrating an example of a configuration of an RIS-Fwd (relay device) 510B and an RIS-MT (control terminal) 520B according to the second embodiment. The RIS-MT 520B has a receiver 521, a transmitter 522, and a controller 523. Such a configuration is the same as that of the above-described embodiment. The RIS-Fwd 510B includes an RIS 511B and an RIS controller 512B. The RIS 511B is a metasurface configured using a metamaterial. For example, RIS 511B is configured by disposing extremely small structures relative to the wavelength of radio waves in an array, and the direction and/or beam shape of the reflected waves can be arbitrarily designed by making the structures different shapes depending on their disposition location. The RIS 511B may be a transparent dynamic metasurface. The RIS 511B may be configured by stacking a transparent glass substrate on transparent version of a metasurface substrate on which a large number of small structures are regularly disposed, and may be capable of dynamically controlling three patterns of a mode of transmitting an incident radio wave, a mode of transmitting a part of a radio wave and reflecting a part thereof, and a mode of reflecting all radio waves by minutely moving the stacked glass substrate. The RIS controller 512B controls the RIS 511B in response to an RIS control signal from the controller 523 in the RIS-MT 520B. The RIS controller 512B may include at least one processor and at least one actuator. The processor interprets an RIS control signal from the controller 523 in the RIS-MT 520B to drive the actuator in response to the RIS control signal.

### (3) Other Embodiments

In the above-described embodiment, an example in which the relay apparatus performing relay transmission is the NCR apparatus 500A or an RIS apparatus 500B has been described. However, the relay apparatus that performs relay transmission is not limited to the NCR apparatus 500A or the RIS apparatus 500B, and may be an Integrated Access and Backhaul (IAB) node defined in the technical specifications of 3GPP.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

In the above-described embodiment, an example in which the base station is an NR base station (gNB) has been described, but the base station may be an LTE base station (eNB). The base station may be a relay node such as an IAB node. The base station may be a Distributed Unit (DU) of the IAB node. The UE 100 may be a Mobile Termination (MT) of the IAB node.

That is, the UE 100 may be a terminal function unit (a type of communication module) for a base station to control a relay device that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

There may be provided a program causing a computer to execute each processing performed by the communication apparatus according to the embodiment described above, for example, the UE 100 (NCR-MT 520A and RIS-MT 520B), the gNB 200, or a relay apparatus. The program may be recorded on a computer-readable medium. The computer-readable medium allows the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing each processing performed by the UE 100, the gNB 200, or the relay apparatus may be integrated, and at least part of the UE 100, the gNB 200, or the relay apparatus may be configured as a semiconductor integrated circuit (chip set, System on a chip (SoC)).

The functions achieved by the UE 100, the gNB 200 (network node), or the relay apparatus may be implemented in circuitry or processing circuitry including a general-purpose processor or a special-purpose processor programmed to achieve the described functions, an integrated circuit, Application Specific Integrated Circuits (ASICs), a Central Processing Unit (CPU), a conventional circuit, and/or combinations thereof. The processor includes a transistor and other circuits, and is considered as circuitry or processing circuitry. The processor may be a programmed processor that executes a program stored in a memory. In the present description, circuitry, units, means are hardware programmed to achieve or hardware to execute the described functions. The hardware may be any hardware disclosed in the present description, any hardware programmed to achieve or known to execute the described functions. When the hardware is a processor considered to be a type of circuitry, the circuitry, means, or units are a combination of hardware and software used to configure the hardware and/or processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### (4) Supplementary Note A

Features relating to the embodiments described above will be described below as supplements.

### Supplementary Note 1

A communication method using a relay apparatus including a relay device configured to perform a relay operation of relaying a radio signal transmitted between a network and a user equipment, and a control terminal configured to receive a control signal used for control of the relay device from the network, the communication method including:
camping, by the control terminal in a radio resource control (RRC) idle mode, on a suitable cell in which a normal service is provided; and
initiating, by the control terminal in the RRC idle mode, an RRC connection establishment procedure of transitioning to an RRC connected mode based on having camped on the suitable cell.

### Supplementary Note 2

The communication method according to Supplementary Note 1, in which
the initiating includes camping on the suitable cell and initiating the RRC connection establishment procedure in response to an OAM client of the control terminal generating uplink data.

### Supplementary Note 3

The communication method according to Supplementary Note 1, in which
the initiating includes camping on the suitable cell and initiating the RRC connection establishment procedure in response to a request from a NAS of the control terminal to an AS of the control terminal being made.

### Supplementary Note 4

The communication method according to Supplementary Note 1, in which
the initiating includes spontaneously initiating, by the AS of the control terminal, the RRC connection establishment procedure in response to having camped on the suitable cell.

### Supplementary Note 5

The communication method according to any of Supplementary Notes 1 to 4, further including:
receiving, by the control terminal from the network, an RRC Release message causing the control terminal to transition to the RRC idle mode;
transitioning to the RRC idle mode in response to receiving the RRC Release message; and
controlling so as not to initiate the RRC connection establishment procedure even when camping on the suitable cell when having transitioned to the RRC idle mode in response to receiving the RRC Release message.

### Supplementary Note 6

A communication method using a relay apparatus including a relay device configured to perform a relay operation of relaying a radio signal transmitted between a network and a user equipment, and a control terminal configured to receive a control signal used for control of the relay device from the network, the communication method including:
camping, by the control terminal in a radio resource control (RRC) idle mode, on an acceptable cell in which a limited service is provided;
generating, by the control terminal in the RRC idle mode, uplink data in the acceptable cell; and
initiating, by the control terminal in the RRC idle mode, an RRC connection establishment procedure of transitioning to an RRC connected mode in response to generating the uplink data.

### Supplementary Note 7

The communication method according to Supplementary Note 6, further including:
transmitting, in the RRC connection establishment procedure to the acceptable cell, an RRC Setup Request message including information indicating an emergency call.

### Supplementary Note 8

The communication method according to Supplementary Note 6 or 7, in which the initiating includes initiating the RRC connection establishment procedure in response to generating the uplink data and the acceptable cell broadcasting an indicator indicating support of the relay apparatus.

### Supplementary Note 9

The communication method according to any of Supplementary Notes 6 to 8, in which the relay apparatus and the acceptable cell belong to different PLMNs, and
the initiating includes initiating the RRC connection establishment procedure in response to generating the uplink data and the acceptable cell broadcasting an indicator indicating support of an outgoing call of the relay apparatus of another PLMN.

### Supplementary Note 10

The communication method according to any of Supplementary Notes 6 to 9, further including: receiving, by the control terminal in the acceptable cell, communication restriction information from the network, the communication restriction information indicating a content of a communication restriction of an outgoing call from the relay apparatus; and
performing, by the control terminal that has transitioned to the RRC connected mode, communication with the network restricted in accordance with the communication restriction information.

### (5) Supplementary Note B

### 1. Introduction

RAN #99 approved a three month extension of work items for Network Control Repeater (NCR) to solve the remaining issues in RAN2 #119bis-e, RAN2 #120, and RAN2 #121.

In the present supplementary note, unsolved (open)/potential issues of RAN2 left to the NCR will be discussed.

### 2. Discussion

2.1. Issues regarding NCR-MT RRC State and NCR-Fwd on/off
2.1.1. Unsolved Issues related to RRC Release

In the RAN2 #120, the following agreement was achieved.

NCR-Fwd on/off:
When an NCR-MT is in an RRC connected mode, an NCR-Fwd can be turned on or off in accordance with the side control information received from a gNB.
After the NCR-MT enters the RRC inactive mode, the NCR-Fwd can be turned on or off in accordance with the configuration received last from the gNB.
Further studies are required for release to the RRC idle.

### NCR-MT RLF:

After the NCR-MT declares RLF, the NCR-MT performs cell selection and triggers RRC re-establishment;
When the NCR-MT enters into the RRC idle state without finding a suitable cell, the NCR-Fwd turns off;
During an RRC re-establishment procedure, the NCR-Fwd is off.
   RAN2 #121 agreed the following agreement.
When the side control configuration is deleted, forwarding is always turned off. This does not exclude solutions from RAN1.
The network needs to be able to transmit the NCR-MT to RRC idle.

The agreement “forwarding turns off every time the side control configuration is deleted” means that RAN2 intends to delete the side control configuration by using the RRC reconfiguration, and RAN2 itself does not introduce an explicit “off” indication in the RRC release (that is, unless RANI decides something different). However, RANI did not agree to such an explicit indication and concluded that WI is completed in the perspective of RANI. Hence, confirming these conditions in RAN2 is meaningful.

Proposition 1: RAN2 needs to confirm that, to turn off the NCR-Fwd, only the RRC reconfiguration is used to delete the side control configuration before the gNB releases the NCR-MT to idle state.

For the NCR in the inactive state, RAN2 #120 reached the agreement that “after the NCR-MT enters into the RRC inactive mode, the NCR-Fwd can be turned on or off in accordance with a configuration received last from the gNB”. However, for the NCR-MT in the idle state, RAN2 #121 does not have a clear agreement on the operation of the NCR-Fwd. When Proposition 1 is confirmed, it is clear that the operation of the NCR-MT in the idle state coincides with the operation in the inactive state. Thus, confirming is similarly required.

Proposition 2: RAN2 should confirm, after the NCR-MT enters into the RRC idle mode, the same as in the inactive, that the NCR-Fwd can be turned on or off in accordance with the configuration received last from the gNB.

As RAN2 agreed that “the network should be able to transmit the NCR-MT in the RRC idle”, the gNB may intentionally put the NCR-MT into the idle state for reasons such as power saving of the NCR and network congestion. However, since RAN paging cannot be used for the NCR-MT in the idle state, the gNB has no way to cause the NCR-MT to transition to the connected state, that is, unreachable. Thus, it is clear that when the NCR is released to the idle state, the NCR is no longer a network-controlled repeater and is considered similar to a legacy RF repeater, for example.

Observation 1: For example, even when the gNB intentionally puts the NCR-MT into the idle state for reasons such as power saving of the NCR and network congestion, the gNB cannot page the NCR-MT in the idle state.

That is, the OAM server generates DL OAM traffic (U-plane data) that triggers the AMF to initiate CN paging to the NCR-MT. However, it is not clear how the OAM server recognize that the NCR-MT is in the idle state, because it is assumed that there is no way to transmit UL OAM traffic (U-plane data, for example, indicating that being released to idle) when the gNB releases the NCR-MT, that is, when the NCR-MT receives the RRC release.

Further, while the gNB has intentionally released the NCR-MT for some purposes, it is somewhat unnatural for the OAM server to force the NCR-MT back to be connected. In order to solve these issues, some coordination is required between the gNB-OAM and the NCR-OAM. However, it means increasing the burden of the operator or abandoning the interoperability of multi-vendors.

Observation 2: The DL OAM traffic may be an option to trigger the AMF to page an NCR-MT in the idle state, but it requires coordination between the gNB-OAM and the NCR-OAM, leading to less efficient network operation and less interoperability. Another implementation option is to use the OAM client on the NCR-MT. The NCR-MT transitions to the idle state not only by the release but also by a failure (RLF, RRC resume failure, or the like) or initial access (power on or the like). In a case of the failure and the initial access, the OAM client may generate UL OAM traffic (that is, U-plane data) for connection or the like with the OAM server. A UL packet triggers the RRC connection establishment procedure as it currently does. That is, in a case of the NCR-MT in the idle state, the NCR-MT initiates RRC connection establishment immediately after being released from the gNB, because the RRC connection establishment is an automatic process.

Observation 3: The UL OAM traffic may be another option to trigger the NCR-MT to initiate the RRC connection establishment, but may occur immediately after the gNB releases the NCR-MT to the idle state, that is, immediately after a “ping-pong” RRC state transition.

To return the RRC state control to the gNB, a wake-up timer was proposed and discussed offline and online in RAN2 #121. The idea is that the NCR-MT starts a timer (when configured with the RRC release) and when the timer expires, the NCR-MT initiates the RRC connection establishment procedure. This simple solution solves the problem mentioned in Observation 2, and the gNB can control the NCR-MT in the idle state.

Thus, the NCR-MT starts a timer (when configured in the RRC release) and while the timer is running, the NCR-MT is disallowed to initiate the RRC connection establishment procedure. With this solution, the problem mentioned in Observation 3 is solved and the gNB can control the NCR-MT in the idle state.

It is also considered that these timers may be mixed, that is, one timer may serve as both the wake-up timer and the disallowing timer, to accommodate various implementations. In other words, the NCR-MT in the idle state can still be under the network control.

It should be noted that when the OAM solution like Observation 2 and/or Observation 3 is desired, the gNB always chooses the option of not configuring the timer in the RRC release. Thus, the solution is not harmful and ensures an efficient network operation and interoperability.

RAN2, therefore, should agree to introduce a timer in the RRC release. Further studies are required for an accurate timer value and the details of the NCR-MT operation.

Proposition 3: RAN2 should agree to introduce a wake-up timer and/or a disallowing timer in the RRC release to cause the UE to transition to the connected under the control of the gNB. Further studies are required for an accurate timer value and the NCR-MT operation.

### 2.1.2. Potential Issues in RRC Re-establishment

RAN2 #120 agreed to the following description.

### NCR-MT RLF:

After the NCR-MT declares RLF, the NCR-MT performs cell selection and triggers RRC re-establishment;
When the NCR-MT enters into the RRC idle state without finding a suitable cell, the NCR-Fwd turns off;
During an RRC re-establishment procedure, the NCR-Fwd is off.

According to the agreement on the RRC re-establishment, the following steps and potential issues can be specified:
Step 1: The NCR-MT declares the RLF and starts cell selection and RRC re-establishment. During these procedures, the NCR-Fwd is off as is already agreed.
Step 2a: When the NCR-MT selects the same cell and the RRC re-establishment is successfully completed, whether the NCR-Fwd resumes ON according to the last configuration is an issue.
Step 2b: When the NCR-MT selects a different cell and the RRC re-establishment is successfully completed, whether the NCR-Fwd is off or not is an issue.

For the potential problem of step 2a, since the NCR has a configuration provided by the same cell, in most cases, the NCR-Fwd is considered to be able to resume operation with the last configuration that the NCR-Fwd has. In this case, signaling overhead for reconfiguring the NCR can be avoided.

On the other hand, since the RLF has occurred in the NCR-MT, the gNB may not prefer such automatic resumption of the NCR-Fwd operation and, for example, in such a case, the gNB may change the NCR configuration. Hence, it is an option that the gNB explicitly indicate whether the operation of the NCR-Fwd should be resumed with the last configuration or should be turned off, by the RRC reconfiguration or the RRC re-establishment in advance, for example.

As another option, it is considered to make the NCR-Fwd off, even after the RRC re-establishment to the same cell has succeeded. This is either a hard-coded regulation or the instruction of the gNB as described above. In this case, when the NCR-MT declares the RLF (or initiates the RRC re-establishment procedure), the last RRC configuration (and the last instruction with the side control information) should be discarded.

Proposition 4: RAN2 should discuss whether the NCR-Fwd will resume the operation with the last configuration when the RRC re-establishment to the same cell has succeeded.

For the potential problem of step 2b, the last configuration saved in the NCR-MT is provided by the last serving cell and not by a new cell. Therefore, it is easy for the NCR to be provided with a new configuration from the new cell. In this case, when selecting a different cell (or when transmitting an RRC re-establishment request toward a different cell), the NCR-MT should discard the last RRC configuration (and the last instruction with the side control information).

This is similar to the agreement on inactive mode mobility (that is, cell reselection) in RAN2 #121, which is as follows.

When the NCR-MT in the RRC inactive state reselects a cell different from the last serving cell having received the side control configuration, the NCR-Fwd turns off.

Proposition 5: RAN2 should discuss whether the NCR-MT will discard the last configuration when the RRC re-establishment to a different cell is initiated or normally completed.

### 2.1.3. Potential Issues in Cell Reselection

RAN2 #120 agreed to the following description.
The NCR-MT forcedly supports cell reselection and RRM measurement in the RRC idle and the RRC inactive.
In Rel-18, the NCR-MT supports neither handover nor the RRM measurement in the RRC connected.

One potential issue with the cell reselection is priority processing for a specific cell. In the legacy RF repeater, disposition is determined by network planning and/or RF measurement on site. Thus, it is assumed that a desired cell(s) is planned for each NCR, that is, the network planning determines a relationship between a serving cell and an NCR. Such a desired cell may be configured by the NCR through the OAM.

Observation 4: The NCR can configure a desired cell, for example, through the OAM, in which the desired cell means a cell that the NCR-MT is going to camp on and/or connect to. In this case, the NCR-MT should avoid camping on (or connecting) in an undesired

cell. The NCR-MT, therefore, should give higher priority to the desired cell. While cell selection widely allows implementation-specific operations (that is, the NCR-MT selects any cell as long as the cell is suitable), the cell reselection consists of a set of operations determined by specifications (inter-frequency cell reselection criterion, ranking, and the like). A standardized support, therefore, is required to ensure the network planning of the NCR.

The simplest approach is to enhance priority processing of cell reselection. Allowing the NCR-MT to consider the desired cell as of the highest priority is required, similarly as in an MBS frequency or a side link frequency (prioritized depending on the preference of the UE). This enhancement allows the NCR-MT to constantly measure the desired cell and to attempt to reselect, and allows to minimize the possibility of camping on/connecting to an undesired cell.

This is because ranking may cause the NCR-MT to reselect an undesired cell with the same frequency when considering that the NCR-MT may be disposed at a cell edge (that is, a coverage of a macro cell is extended).

Proposition 6: RAN2 should discuss whether the NCR-MT is allowed to give higher priority to the desired cell (that is, the cell of interest) in the cell reselection procedure.

Yet another potential issue is when the NCR-MT connects to an undesired cell after the cell reselection or the RRC re-establishment. From the perspective of the NCR, reconnection to the desired cell is required. From the perspective of the gNB, the RRC connection with the NCR-MT makes no sense in the end. RAN2 has already agreed that “the NCR-MT does not support handover”. Hence, the gNB can only release the NCR-MT, but the NCR-MT will follow the cell reselection procedure after transitioning to the idle state. Thus, it is not guaranteed that the NCR-MT camps on/reconnects to the desired cell. In this case, redirection may be enhanced to cause the NCR-MT to camp on the desired cell. However, it is not clear as to whether the gNB can acquire the cell that the NCR desires (for example, a cell configured by the OAM).

Proposition 7: RAN2 should discuss whether to enhance the redirection in order to move the NCR-MT from a desired cell to another desired cell (that is, instead of handover).

### 2.2. Access Control Issuc

2.2.1. Unsolved Issues when Camping on in Allowable Cell or No Cell Found
Further studies are required for RAN2 #121.

Agreement: After cell reselection, the NCR-MT resumes to be able to receive the side control configuration from a new gNB (the network configuration using the existing specifications makes it possible). Further studies are required for a case that the NCR-MT has moved back to an acceptable cell and a case that no cell is found.

In other words: After cell reselection, the NCR-MT resumes to be able to receive the side control configuration from a new gNB (the network configuration using the existing specifications makes it possible). Further studies are required for a case that the NCR-MT selects/reselects an allowable cell or a case that the NCR-MT returns without finding a cell.

The first sentence “After cell reselection, the NCR-MT resumes to be able to receive a side control configuration from a new gNB (network configuration using the existing specifications makes it possible)” means, for example, that the gNB configures with an RAN Notification Area (RNA) that includes only one cell, and the RRC connection needs to be resumed every time the NCR-MT in the RRC inactive mode reselects another cell.

Observation 5: When RNA is configured by only one cell, the NCR-MT always resumes the RRC connection every time the reselecting of another cell is performed.

In the interpretation of the above studying items, the issue is for the NCR-MT to transition from the inactive state to the idle state, and the transition is a case that the NCR-MT camps on in an allowable cell. This problem is considered to be similar to the case that the gNB releases the NCR-MT to the idle state (that is, the case that the gNB cannot page the NCR-MT) as in the above-described Observation 1, and is concerned with a difference between intentional release of the NCR-MT by the gNB or automatic transition of the NCR-MT to the idle state.

Observation 6: The NCR-MT in the inactive state automatically transitions to the idle state upon entering into a receivable cell.

On the other hand, the NCR-MT maintains the inactive state, and searches for a suitable cell when a suitable cell is not found (that is, an Any cell selection state). When a suitable cell is found, the NCR-MT returns to the Camped normally state, that is, the same state as in Observation 5. When only acceptable cells are found, the NCR-MT enters into a Camped on any cell state, that is, the same state as in Observation 6. Thus, there is no need to consider the special case that the NCR-MT cannot find a cell.

Observation 7: When the NCR-MT does not detect a cell, there is no particular problem.

The issue to be discussed here, therefore, is how the NCR-MT in the idle state initiates the RRC connection establishment procedure (that is, similar to the agreement “after cell reselection, the NCR-MT resumes to be able to receive the side control configuration from a new gNB”). The following two cases are considered.
Case 1: The NCR-MT camps on in an allowed cell and reselects a suitable cell;
Case 2: The NCR-MT still camps on in the allowed cell.

In case 1, the NCR-MT automatically transitions to the idle state, and thus the RRC connection establishment procedure needs to be initiated autonomously. The simplest way is for the NCR-MT to generate a UL packet, which can be achieved by OAM client implementation, that is, the OAM client of the NCR-node transmits a UL OAM traffic (that is, U-plane data) when the NCR-MT moves from an allowed cell to a suitable cell. Similar to Observation 3 above, when the power of the NCR node is turned on, that is, for the first access and registration as well, a similar OAM client implementation is required. Another possible solution is that when the AS in the idle state finds a suitable cell, the AS instructs (or requests) the NAS to initiate the RRC connection establishment. However, this solution has an impact on the specification. Hence, RAN2 should discuss whether the NCR-MT can initiate MO data with OAM implementation or a standardized solution.

Proposition 8: RAN2 should discuss whether the MO data (that is the UL packet) can be initiated by the OAM client implementation when the NCR-MT moves from an allowed cell to a suitable cell.

In Case 2, the NCR-MT is allowed only to initiate an emergency call (that is, Limited service state). In most cases, the UE is disallowed to initiate the MO data that is an OAM client packet as in Proposition 8, for example. It is considered natural that the same principle applies to the NCR, that is, the NCR-MT is not allowed to initiate an MO data call, except for an emergency call. Note that the NCR-MT is not considered to be a UE, but a network node. Thus, it is worth discussing whether the MO data (such as the UL OAM traffic) can be treated as an emergency call.

Clearly, when an acceptable cell does not broadcast the NCR-Supported IE in an SIB, the NCR-MT camps on a cell as a UE. Hence, the MO data should not be an emergency call as it currently is.

On the other hand, when an acceptable cell broadcasts the NCR-Supported IE in the SIB, the NCR-MT camps on a cell as an NCR-MT and the cell actually allows an access of the NCR-MT. In this case, since the NCR-MT in the idle state reconnects to a network, or when depending on PLMN of an acceptable cell, the MO data may be initiated (treated) as an emergency call.

Proposition 9: RAN2 should discuss whether the NCR-MT is allowed to initiate the MO data (for example, the UL OAM traffic) as an emergency call in an allowed cell when a cell broadcasts the NCR-Supported IE in an SIB 1.

### 2.2.2. Potential Issues in PRACH Resource

In IAB, a specific PRACH scene (RO) can be provided to avoid possible collision. These opportunities are defined in the following IE to extend the common configuration of the UE.

Since the NCR is considered a network node like the IAB node, PRACH collision with the UE should also be avoided. For the UE in an extended coverage provided by the NCR, a preamble transmitted by the UE is transferred to the gNB by the NCR, whereas in a case of the IAB, the preamble transmitted by the UE is terminated by the IAB node. Hence, it is considered to be a more serious problem for the NCR in terms of a collision of the PRACH at a gNB receiving side.

In this sense, it is worth studying whether a PRACH resource separated from the UE should be provided to the NCR-MT. When it is required, further studies are required as to whether the separated PRACH resource is defined by separated (as in Rel-16 IAB) RO or defined by PRACH partitioning (that is, as part of Rel-17 RedCap, SDT, slicing, and Feature Combination Preambles defined by coverage extension).

Proposition 10: RAN2 should discuss whether to define the PRACH resource of the individual NCR-MT.

### REFERENCE SIGNS

1: Mobile communication system
100: UE
200: gNB
210: Transmitter
220: Receiver
230: Controller
240: Backhaul communicator
300A: AMF
400: OAM server
500A: NCR apparatus
510A: NCR-Fwd
520A: NCR-MT
500B: RIS apparatus
510B: RIS-Fwd
520B: RIS-MT
511A: Wireless unit
511a: Antenna
511b: RF circuit
511c: Directivity controller
512A: NCR controller
512B: RIS controller
521: Receiver
522: Transmitter
523: Controller
530: Interface

1. A communication method using a relay apparatus comprising a relay node configured to perform a relay operation of relaying a radio signal transmitted between a network and a user equipment, and a control terminal configured to receive a control signal used for control of the relay node from the network, the communication method comprising:
camping, by the control terminal in a radio resource control (RRC) idle mode, on a suitable cell in which a normal service is provided; and
initiating, by the control terminal in the RRC idle mode, an RRC connection establishment procedure of transitioning to an RRC connected mode based on having camped on the suitable cell.

2. The communication method according to claim 1,
wherein the initiating comprises camping on the suitable cell and initiating the RRC connection establishment procedure in response to an OAM (Operation, Administration, and Maintenance) client of the control terminal generating uplink data.

3. The communication method according to claim 1,
wherein the initiating comprises camping on the suitable cell and initiating the RRC connection establishment procedure in response to a request from a Non-Access Stratum (NAS) in the control terminal to an Access Stratum (AS) in the control terminal being made.

4. The communication method according to claim 1,
wherein the initiating comprises spontaneously initiating, by the AS of the control terminal, the RRC connection establishment procedure in response to having camped on the suitable cell.

5. The communication method according to claim 1, further comprising:
receiving by the control terminal from the network, an RRC Release message causing the control terminal to transition to the RRC idle mode;
transitioning to the RRC idle mode in response to receiving the RRC Release message; and
controlling so as not to initiate the RRC connection establishment procedure even when camping on the suitable cell when having transitioned to the RRC idle mode in response to receiving the RRC Release message.

6. A communication method using a relay apparatus comprising a relay node configured to perform a relay operation of relaying a radio signal transmitted between a network and a user equipment, and a control terminal configured to receive a control signal used for control of the relay node from the network, the communication method comprising:
camping, by the control terminal in a radio resource control (RRC) idle mode, on an acceptable cell in which a limited service is provided;
generating, by the control terminal in the RRC idle mode, uplink data in the acceptable cell; and
initiating, by the control terminal in the RRC idle mode, an RRC connection establishment procedure of transitioning to an RRC connected mode in response to generating the uplink data.

7. The communication method according to claim 6, further comprising:
transmitting, in the RRC connection establishment procedure to the acceptable cell, an RRC Setup Request message comprising information indicating an emergency call.

8. The communication method according to claim 6
wherein the initiating comprises initiating the RRC connection establishment procedure in response to generating the uplink data and the acceptable cell broadcasting an indicator indicating support of the relay apparatus.

9. The communication method according to claim 6,
wherein the relay apparatus and the acceptable cell belong to different PLMNs, and
the initiating comprises initiating the RRC connection establishment procedure in response to generating the uplink data and the acceptable cell broadcasting an indicator indicating support of an outgoing call of the relay apparatus of another PLMN.

10. The communication method according to claim 6, further comprising:
receiving, by the control terminal in the acceptable cell, communication restriction information from the network, the communication restriction information indicating a content of a communication restriction of an outgoing call from the relay apparatus; and
performing, by the control terminal that has transitioned to the RRC connected mode, communication with the network restricted in accordance with the communication restriction information.

11. A control terminal, comprising:
a receiver configured to receive, from a network, a control signal used for control of a relay node configured to perform a relay operation of relaying a radio signal transmitted between the network and a user equipment; and
a controller configured to:
camp, while the control terminal is in a radio resource control (RRC) idle mode, on an acceptable cell in which a limited service is provided;
generate, while the control terminal is in the RRC idle mode, uplink data in the acceptable cell; and
initiate, while the control terminal is in the RRC idle mode, an RRC connection establishment procedure of transitioning to an RRC connected mode in response to generating the uplink data.
